(19) United States
(12) Patent Application Publication
(10) Pub. No.: US 2015/0044513 A1
(43) Pub. Date: Feb. 12, 2015

(54) CATHODE ACTIVE MATERIAL, CATHODE, SECONDARY BATTERY, BATTERY PACK, ELECTRIC VEHICLE, ELECTRIC POWER STORAGE SYSTEM, ELECTRIC POWER TOOL, AND ELECTRONIC APPARATUS

(71) Applicant: Sony Corporation, Tokyo (JP)

(72) Inventors: Kazuaki Endoh, Fukushima (JP); Yosuke Hosoya, Fukushima (JP); Hironobu Tsuji, Fukushima (JP); Kazunari Motohashi, Fukushima (JP)

(21) Appl. No.: 14/384,280

(22) PCT Filed: Feb. 14, 2013
(86) PCT No.: PCT/JP2013/053475

§ 371 Date: Sep. 10, 2014

(30) Foreign Application Priority Data
Mar. 26, 2012 (JP) 2012-068936

(51) Int. Cl. H01M 4/36; H01M 4/131; H01M 4/505; H01M 4/52; H01M 4/525

(52) U.S. Cl. CPC H01M 4/366; H01M 4/523; H01M 4/525; H01M 4/505; H01M 4/131; H01M 2004/028
USPC 429/7; 429/220; 429/221; 429/223; 429/224; 429/188; 429/222

(57) ABSTRACT

A secondary battery capable of obtaining superior battery characteristics is provided. The cathode according to the technology includes a lithium-containing compound. The lithium-containing compound is a compound obtained by inserting an element M2 different from an element M1 in a crystal structure of a surface layer region of a composite oxide represented by a general formula of Li₁₊ₐ(Mn_{b}Co_{c}Ni_{1-b-c})₁₋ₐM1_{d}O_{2-c} (the element M2 is Mg or the like). A mole fraction R1 represented by [R1 (percent)=(a substance amount of the element M2/sum of substance amounts of Mn, Co, Ni, and the element M2)×100] on a central side of the lithium-containing compound is smaller than the mole fraction R1 on a surface layer side of the lithium-containing compound.

### TECHNICAL FIELD

The present technology relates to a cathode active material as a lithium-containing compound, to a cathode and a secondary battery that use the cathode active material, and to a battery pack, an electric vehicle, an electric power storage system, an electric power tool, and an electronic apparatus that use the secondary battery.

### BACKGROUND ART

In recent years, various electronic apparatuses such as a mobile phone and a personal digital assistant (PDA) have been widely used, and it has been desired to further reduce the size and the weight of the electronic apparatuses and to achieve their long lives. Accordingly, as an electric power source, a battery, in particular, a small and light-weight secondary battery capable of providing high energy density has been developed. In these days, it has been considered to apply such a secondary battery not only to the foregoing electronic apparatuses, but also to various other applications. Representative examples of such other applications may include a battery pack attachably and detachably mounted on the electronic apparatuses or the like, an electric vehicle such as an electric automobile, an electric power storage system such as a home electric power server, and an electric power tool such as an electric drill.

Secondary batteries utilizing various charge-discharge principles to obtain a battery capacity have been proposed. In particular, a secondary battery utilizing insertion and extraction of an electrode reactant or a secondary battery utilizing precipitation and dissolution of an electrode reactant has attracted attention, since such a secondary battery provides higher energy density than a lead battery, a nickel-cadmium battery, and the like.

The secondary battery includes a cathode, an anode, and an electrolytic solution. The cathode contains a cathode active material contributing to a charge-discharge reaction. As the cathode active material, generally, a lithium-containing compound such as LiCoO₂ and LiNiO₂ is widely used. Since the cathode active material that directly relates to a charge-discharge reaction largely affects battery performance, various studies have been made on a composition and the like of the cathode active material.

Specifically, in order to improve charge-discharge cycle characteristics, a coat of a metal oxide is formed on the surface of a cathode containing a composite oxide represented by a general formula of LiₓNi_{1-y}Co_{y}O_{z} (for example, see Patent Literature 1). In the formula, x and the like satisfy 0<x<1.3, 0≦y≦1, and 1.8<z<2.2. The metal oxide may be BeO, MgO, or the like.

In order to improve structural stability and thermal stability of a cathode active material, the surface of a composite oxide represented by a general formula of LiA_{1-x-y}BₓC_{y}O₂ is coated with a metal oxide (for example, see Patent Literature 2). In the formula, A represents Co or the like, B represents Ni or the like, C represents Al or the like, and x and the like satisfy 0<x≦0.3 and 0≦y≦0.01. The metal oxide may be an oxide of Mg, an oxide of Al, or the like.

In order to improve a cycle life and an initial capacity, the surface of a spinel-type composite oxide represented by a general formula of LiₐMn_{b}M_{c}O₄ is coated with a metal oxide (for example, see Patent Literature 3). In the formula, M represents Mg or the like, and a and the like satisfy 1.0≦a≦1.15, 1.8≦b≦1.94, 0.01≦c≦0.10, and a+b+c=3. The metal oxide may be an oxide of Al, an oxide of Co, or the like. A metal element in such an oxide forms a solid solution with LiₐMn_{b}M_{c}O₄.

In order to improve capacity characteristics, life characteristics, and thermal stability, in a cathode active material including an inner bulk section and an outer bulk section, the metal composition exists at continuous concentration gradient from the interface between the inner bulk section and the outer bulk section toward the surface of the active material (for example, see Patent Literature 4). The inner bulk section may be LiNi_{0.8}Co_{0.13}Mn_{0.07}O₂ or the like represented by a general formula of LiₐNi_{1-x-y-z}CoₓMn_{y}M_{z}O_{2-δ}X_{δ}. In the formula, M represents Mg or the like, X represents F or the like, and a and the like satisfy 0.95≦a≦1.2, 0.01≦x≦0.5, 0.01≦y≦0.5, 0.005≦z≦0.3, and 0.05≦x+y+z≦0.4. The outer bulk section may be LiNi_{0.4}Co_{0.4}Mn_{0.2}O₂ or the like represented by a general formula of LiₐNi_{1-x-y-z}CoₓMn_{y}M_{z}O_{2-δ}X_{δ}. In the formula, M represents Mg or the like, X represents F or the like, and a and the like satisfy 0.95≦a≦1.2, 0.01≦x≦0.4, 0.01≦y≦0.5, 0.002≦z≦0.2, and 0.4≦x+y+z≦0.95.

In order to sufficiently utilize high capacity characteristics of an Si-based anode active material or an Sn-based anode active material, a lithium-rich composite oxide represented by a general formula of LiₕMnᵢCoⱼNiₖO₂ is used (for example, see Patent Literature 5). In the formula, h and the like satisfy h=[3(1+x)+4a]/3(1+a), i=[3α(1+x)+2a]/3(1+a), j=β(1−x)/(1+a), k=γ(1−x)/(1+a), 0<a<1, α>0, β>0, γ>0, α+β+∈=1, and 0≦x<⅓. The composite oxide is a solid solution represented by Li₁₊ₓ(Mn_{α}Co_{β}Ni_{γ})₁₋ₓO₂.aLi_{4/3}Mn_{2/3}O₂.

In order to improve a battery capacity and charge-discharge cycle characteristics, an oxide containing Li, Ni, and/or the like is formed on the surface of a composite oxide represented by a general formula of Li_{1+w}Co_{1-x-y}GaₓO_{2-z} (for example, see Patent Literature 6). In the formula, M represents Mg or the like, and w and the like satisfy −0.01≦w≦0.1, 0.0001<x<0.05, 0≦y<0.4, and −0.1≦z≦0.2.

In order to obtain a high capacity and superior cycle characteristics and to suppress gas generation inside a battery at the time of high temperature, a covering layer is provided on surfaces of composite oxide particles containing Li and a transition metal element (for example, see Patent Literature 7). The covering layer contains at least one element M (different form the transition metal contained in the composite oxide particles) selected from the group consisting of the Group 2 elements and Group 13 elements; and at least one element X of P, Si, and Ge. The elements M and X show distributions different from each other.

In order to improve cycle characteristics, a covering layer formed of an oxide containing Li, Ni, and Mn is provided on surfaces of composite oxide particles represented by a general formula of Li₁₊ₓCo_{1-y}M_{y}O_{2-z} (for example, see Patent Literature 8). In the formula, M represents Mg or the like, and x and the like satisfy −0.1≦x≦0.1, 0≦y<0.5, and −0.1≦z≦0.2. In the covering layer, the concentration of Mn in the outer layer portion is higher than that in the inner layer portion.

### CITATION LIST

### Patent Literatures

[Patent Literature 1]: Japanese Patent No. 3172388
[Patent Literature 2]: Japanese Patent No. 3691279
[Patent Literature 3]: Japanese Unexamined Patent Application Publication No. 2009-206047
[Patent Literature 4]: Japanese Unexamined Patent Application Publication (Translation of PCT Application) No. 2009-525578
[Patent Literature 5]: Japanese Unexamined Patent Application Publication No. 2009-158415
[Patent Literature 6]: Japanese Unexamined Patent Application Publication No. 2007-335169
[Patent Literature 7]: Japanese Unexamined Patent Application Publication No. 2009-054583
[Patent Literature 8]: Japanese Unexamined Patent Application Publication No. 2006-331940

### SUMMARY OF INVENTION

In recent years, high performance and multi-functions of the electronic apparatuses and the like to which the secondary battery is applied are increasingly developed. Frequency in use of the electronic apparatuses and the like is increased. Therefore, further improvement of battery characteristics of the secondary battery has been desired.

Therefore, it is desirable to provide a cathode active material, a cathode, a secondary battery, a battery pack, an electric vehicle, an electric power storage system, an electric power tool, and an electronic apparatus that are capable of obtaining superior battery characteristics.

A cathode active material according to an embodiment of the present technology is a lithium-containing compound obtained by inserting an element M2 different from an element M1 in a crystal structure of a surface layer region of a composite oxide represented by the following Formula (1). The element M2 is at least one of Mg, Ca, Ti, Zr, S, F, Fe, Cu, B, Al, P, C, Mn, Ni, and Co, and a mole fraction R1 represented by the following Formula (2) on a central side of the lithium-containing compound is smaller than the mole fraction R1 on a surface layer side of the lithium-containing compound.

Li₁₊ₐ(Mn_{b}Co_{c}Ni_{1-b-c})₁₋ₐM1_{d}O₂₋ₑ (1)

(In the formula (1), M1 is at least one of Al, Mg, Zr, Ti, Ba, B, Si, and Fe; and a to e satisfy 0<a<0.25, 0.5≦b<0.7, 0≦c<1−b, 0≦d≦1, and 0≦e≦1.)

R1(%)=(a substance amount of the element M2/sum of substance amounts of Mn, Co, Ni, and the element M2)×100 (2).

A cathode according to an embodiment of the present technology includes the above-described cathode active material. A secondary battery according to the present technology includes a cathode, an anode, and an electrolytic solution, wherein the cathode includes the above-described cathode active material. Further, a battery pack, an electric vehicle, an electric power storage system, an electric power tool, and an electronic apparatus according to embodiments of the present technology include the above-described secondary battery.

The “surface layer region” refers to an outer portion out of the lithium-containing compound, that is, a surface layer portion surrounding the circumference of an inner portion (a central portion) of the lithium-containing compound. More specifically, in a direction from the uppermost surface of the particulate lithium-containing compound to the center thereof, the “surface layer region” refers to a portion in the range from the uppermost surface to a location with a thickness (a depth) corresponding to about 0.1% of the particle diameter (median diameter). The outer portion as the “surface layer region” forms a crystal structure integral (continuous) with the inner portion, and such an outer portion is not separately formed on the surface of the inner portion.

Further, the foregoing term “the element M2 is inserted in the crystal structure of the surface layer region of the composite oxide” refers to a state that, in the crystal structure of the surface layer region of the composite oxide, at least part of the constituent elements of the crystal structure is substituted by the element M2.

According to the cathode active material, the cathode, and the secondary battery according to the embodiments of the present technology, the mole fraction R1 on the central side is smaller than the mole fraction R1 on the surface layer side in the lithium-containing compound having the foregoing composition and the foregoing crystal structure, and therefore superior battery characteristics are obtainable. Further, according to the battery pack, the electric vehicle, the electric power storage system, the electric power tool, and the electronic apparatus that use the secondary battery according to the embodiment of the present technology, similar effects are obtainable.

### BRIEF DESCRIPTION OF THE DRAWINGS

FIG. 1 is a cross-sectional view illustrating a configuration of a secondary battery (cylindrical-type) according to an embodiment of the present technology.

FIG. 2 is a cross-sectional view illustrating an enlarged part of a spirally wound electrode body illustrated in FIG. 1.

FIG. 3 is a perspective view illustrating a configuration of another secondary battery (laminated-film-type) according to the embodiment of the present technology.

FIG. 4 is a cross-sectional view taken along a line IV-IV of a spirally wound electrode body illustrated in FIG. 3.

FIG. 5 is a block diagram illustrating a configuration of an application example (a battery pack) of the secondary battery.

FIG. 6 is a block diagram illustrating a configuration of an application example (an electric vehicle) of the secondary battery.

FIG. 7 is a block diagram illustrating a configuration of an application example (an electric power storage system) of the secondary battery.

FIG. 8 is a block diagram illustrating a configuration of an application example (an electric power tool) of the secondary battery.

### MODE FOR CARRYING OUT THE INVENTION

An embodiment of the present technology will be hereinafter described in detail with reference to the drawings. The description will be given in the following order.

### 1. Cathode Active Material

### 2. Application Examples of Cathode Active Material (Lithium Secondary Batteries)

### 2-1. Cathode and Lithium Ion Secondary Battery (Cylindrical Type)

### 2-2. Cathode and Lithium Ion Secondary Battery (Laminated Film Type)

### 2-3. Cathode and Lithium Metal Secondary Battery

### 3. Applications of Secondary Battery

### 3-1. Battery Pack

### 3-2. Electric Vehicle

### 3-3. Electric Power Storage System

### 3-4. Electric Power Tool

### 1. Cathode Active Material

[Configuration of Cathode Active Material]

A cathode active material according to an embodiment of the present technology is a compound (a lithium-containing compound) containing Li as a constituent element, and for example, may be used for a cathode of a lithium secondary battery (hereinafter simply referred to as a “secondary battery”) or the like.

The lithium-containing compound as a cathode active material is a compound obtained by inserting an element M2 different from an element M1 in a crystal structure of a surface layer region of a composite oxide represented by the following Formula (1). The element M2 is at least one of Mg, Ca, Ti, Zr, S, F, Fe, Cu, B, Al, P, C, Mn, Ni, and Co.

Li₁₊ₐ(Mn_{b}Co_{c}Ni_{1-b-c})₁₋ₐM1_{d}O₂₋ₑ (1)

(In Formula (1), M1 is at least one of Al, Mg, Zr, Ti, Ba, B, Si, and Fe; and a to e satisfy 0<a<0.25, 0.5≦b<0.7, 0≦c<1−b, 0≦d≦1, and 0≦e≦1.)

The lithium-containing compound described here is a lithium-transition-metal composite oxide containing Li, transition metal elements (Mn, Co, and Ni), and other element (M1) as constituent elements, and has a bedded salt-type crystal structure. As seen in the feasible range of a, the lithium-containing compound is a so-called lithium-rich compound.

In the lithium-containing compound, as described above, with the use of the composite oxide (the lithium-rich lithium transition metal composite oxide) shown in Formula (1) as a base material, the element M2 different from the element M1 is inserted only in the crystal structure in the surface layer region of the composite oxide.

For confirmation, a compound in a state that the element M2 has not been therein inserted yet, that is, the base material having the composition shown in Formula (1) is referred to as the “composite oxide” here. In contrast, a compound in a state that the element M2 has been therein inserted, that is, a resultant substance obtained by inserting the element M2 in the crystal structure of the composite oxide with the use of the after-described procedure is referred to as the “lithium-containing compound.”

As described above, the “surface layer region” refers to an outer portion out of the lithium-containing compound, that is, a surface layer portion surrounding the circumference of an inner portion (a central portion) of the lithium-containing compound. More specifically, in a direction from the uppermost surface of the particulate lithium-containing compound to the center thereof, the “surface layer region” refers to a portion in the range from the uppermost surface to a location with a thickness (a depth) corresponding to about 0.1% of the particle diameter (median diameter). The outer portion as the “surface layer region” forms a crystal structure integral (continuous) with the inner portion, and such an outer portion is not separately formed on the surface of the inner portion.

Further, as described above, the foregoing term “the element M2 is inserted in the crystal structure of the surface layer region of the composite oxide” refers to a state that in the crystal structure of the surface layer region of the composite oxide, at least part of the elements of the crystal structure is substituted by the element M2.

In the lithium-containing compound, a mole fraction R1 represented by the following Formula (2) on the central side of the lithium-containing compound is smaller than that on the surface layer side of the lithium-containing compound. The mole fraction R1 is an index indicating the abundance ratio of the element M2 with respect to the abundance of the main constituent elements (Mn, Co, Ni, and the element M2), and may be measured, for example, by using inductively-coupled plasma spectrometry (ICP) and/or the like. Specifically, after the respective substance amounts (mole numbers) of Mn, Co, Ni, and the element M2 existing in the surface layer region of the lithium-containing compound are measured, the mole fraction R1 is calculated from the measurement result.

R1(%)=(the substance amount of the element M2/sum of the substance amounts of Mn, Co, Ni, and the element M2)×100 (2)

The element M2 exists only in the surface layer region of the lithium-containing compound, and the element M2 is inserted only in the crystal structure of the surface layer region, since thereby, superior battery characteristics are obtained at the time of charge and discharge of a secondary battery using the cathode active material.

Specifically, firstly, the crystal structure is stabilized, and resistance is lowered. Therefore, even when charge and discharge are repeated, the lithium-containing compound is less likely to be damaged, and the discharge capacity is less likely to be lowered. Thereby, the battery capacity characteristics and the cycle characteristics are improved.

Secondly, since the central portion (the inner portion not containing the element M2) is protected by the surface layer region (the outer portion containing the element M2), the central portion is isolated from an electrolytic solution. In this case, even when a cathode is strongly oxidized in a charging state of a secondary battery, a decomposition reaction of the electrolytic solution is suppressed, and a decomposition reaction and an elution reaction of the main portion (the central portion) of the lithium-containing compound are suppressed. Therefore, even when charge and discharge are performed, the discharge capacity is less likely to be lowered, and gas (such as oxygen gas) is less likely to be generated by a decomposition reaction of the lithium-containing compound. These advantages are significant particularly in the case of performing charge and discharge in high-temperature environment. Thereby, battery capacity characteristics, cycle characteristics, conservation characteristics, and battery swollenness characteristics are improved.

Thirdly, compared to a case in which a compound (hereinafter referred to as “M2-containing compound”) containing the element M2 as a constituent element is separately formed on the surface of the composite oxide, insertion and extraction of lithium ions are less likely to be inhibited. Therefore, even when charge and discharge are repeated, the discharge capacity is less likely to be lowered. The term “the M2-containing compound is formed on the surface of the composite oxide” refers to a state that the surface of the composite oxide is covered with the M2-containing compound. Such an advantage is also obtained by the fact that, as described above, an inactive coat inhibiting movement of lithium ions is less likely to be formed due to suppression of a decomposition reaction of the electrolytic solution. Thereby, battery capacity characteristics and cycle characteristics are improved.

Fourthly, since the element M2 is inserted in the crystal structure of the composite oxide, even when charge and discharge are repeated, the element M2 is less likely to be dropped from the lithium-containing compound, compared to in a case in which the element M2 is not inserted in the crystal structure. Examples of the “case in which the element M2 is not inserted in the crystal structure” may include, as described above, a case in which the surface of the composite oxide is covered with the M2-containing compound, and the M2-containing compound is formed separately from the composite oxide (so that a discontinuous crystal structure is formed). Thereby, even when charge and discharge are repeated, the foregoing advantages are continuously obtained.

Further, one reason why the base material of the lithium-containing compound is the lithium-rich composite oxide shown in Formula (1) is as follows. In this case, a large amount of Li is therein contained as a constituent element. Therefore, in an anode at the time of the initial charge, a generation reaction of an irreversible capacity is allowed to be completed substantially.

More specifically, at the time of the initial charge and discharge of a secondary battery, a coat (such as an SEI film) is formed on the surface of an anode, and therefore, a so-called irreversible capacity is generated. Accordingly, much of lithium ions extracted from a cathode active material at the time of the initial charge is consumed for generating the irreversible capacity. In this case, in the case where the charging voltage at the time of the initial charge of the secondary battery is a high voltage (such as a voltage equal to or larger than 4.4 V), a sufficient amount of lithium ions is extracted from the cathode active material, and therefore, part of the lithium ions is consumed for generating the irreversible capacity in the anode. Thereby, a generation reaction of the irreversible capacity is completed at the initial charge and discharge. As a result, at the time of charge and discharge after the initial charge and discharge, which is substantial usage time of the secondary battery, the lithium ions extracted from the cathode active material are consumed for generating a battery capacity. Thereby, at the time of charge and discharge after the initial charge and discharge, a high battery capacity is stably obtained.

It is to be noted that, in the case where an anode active material used for the secondary battery together with the cathode active material is a metal-based material or an oxide thereof, such a fact may cause an irreversible capacity. Lithium ions extracted from the cathode active material at the time of the initial charge easily reacts with an element in the metal-based material or oxygen in the oxide irreversibly. The metal-based material may be, for example, a material containing at least one of Si and Sn as constituent elements, since thereby, high energy density is obtained. More specific examples thereof may include any one or more of a simple substance, an alloy, and a compound of Si and a simple substance, an alloy, and a compound of Sn. Although specific examples of the oxide of the metal-based material are not particularly limited, examples thereof may include SiOᵥ (0.2<v<1.4). In particular, in the case where the anode active material is the oxide of the metal-based material, the irreversible capacity tends to be increased. It is to be noted that the irreversible capacity is easily increased similarly in the case where the anode active material is low crystalline carbon, amorphous carbon, or the like.

Further, reasons why a to e in Formula (1) are in the foregoing ranges are as follows.

One reason why a>0 is satisfied is as follows. In the case of a=0, the absolute amount of lithium ions becomes insufficient. Therefore, a generation reaction of an irreversible capacity is not allowed to be completed substantially at the time of the initial charge, and a high battery capacity is not stably obtained at the time of charge and discharge after the initial charge and discharge. In contrast, one reason why a<0.25 is satisfied is as follows. In the case of a≧0.25, lithium ions are consumed for forming a lithium-derived residual product, and therefore, a sufficient battery capacity is not obtainable. Further, in the case where a hydroxide is used as an Li source to form the lithium-containing compound, since gas is generated from the hydroxide, the secondary battery is easily swollen. In particular, a may preferably satisfy 0.1<a<0.25, since a higher effect is obtained thereby.

One reason why b≧0.5 is satisfied is as follows. In the case of b<0.5, the absolute amount of Mn becomes insufficient, and therefore, the lithium-containing compound is not allowed to contain a sufficient amount of Li as a constituent element. Therefore, a generation reaction of an irreversible capacity is not allowed to be completed substantially at the time of the initial charge, and a high battery capacity is not stably obtained at the time of charge and discharge after the initial charge and discharge. In contrast, one reason why b<0.7 is satisfied is as follows. In the case of b≧0.7, Li₂MnO₄ not contributing to a battery capacity is formed, and therefore, the battery capacity is lowered.

One reason why c<1−b is satisfied is as follows. In the case of c≧1−b, the absolute amount of Ni is excessively decreased with respect to the absolute amount of Co relatively, and therefore, a sufficient battery capacity is not obtainable.

In contrast, one reason why d≦1 is satisfied is as follows. In the case of d>1, in view of valency compensation, the lithium-rich lithium-containing compound is not allowed to be stably obtained. Further, in this case, since crystallinity of the lithium-containing compound is lowered, a sufficient battery capacity is not obtainable.

One reason why e≦1 is satisfied is as follows. In the case of e>1, as in the foregoing case of d, the lithium-rich lithium-containing compound is not allowed to be stably obtained in view of valency compensation, and therefore, a sufficient battery capacity is not obtainable.

Further, one reason why the mole fraction R1 on the central side of the lithium-containing compound is smaller than that on the surface layer side of the lithium-containing compound is as follows. In such a case, resistance increase of the surface layer region resulting from existence of the element M2 is suppressed. Thereby, cycle characteristics, conservation characteristics, and the like are improved.

More specifically, in the case where the mole fraction R1 on the central side is larger than that on the surface layer side, the abundance of the element M2 in the surface layer region is excessively large, and therefore, resistance in such a surface layer region is increased. Thereby, cycle characteristics, conservation characteristics, and the like are lowered due to existence of the element M2. Such a tendency is obtained not only in the case where the mole fraction R1 on the central side is larger than that on the surface layer side, but also in the case where the mole fraction R1 is constant from the surface layer side to the central side.

In contrast, in the case where the mole fraction R1 on the central side is smaller than that on the surface layer side, out of the surface layer region of the lithium-containing compound, the abundance of the element M2 on the surface layer side is relatively large, and therefore, the foregoing advantage is obtained due to existence of the element M2. Further, since the abundance of the element M2 on the central side becomes relatively small, resistance increase resulting from existence of the element M2 is suppressed. Thereby, while advantages resulting from existence of the element M2 are exploited, cycle characteristics, conservation characteristics, and the like are improved.

It is to be noted that as long as the mole fraction R1 on the central side of the lithium-containing compound is smaller than that on the surface layer side of the lithium-containing compound, the mole fraction R1 may be continuously (gradually) decreased from the surface layer side to the central side, or may be intermittently decreased. One reason for this is that, as long as the mole fraction R1 on the central side of the lithium-containing compound is smaller than that on the surface layer side of the lithium-containing compound, the foregoing advantage is obtained.

Types of the element M1 in Formula (1) are not particularly limited, as long as the types of the element M1 are any one or more of the foregoing Al and the like. In particular, the element M1 may be preferably Al, Mg, or Ti, and may be more preferably Al, since thereby, higher effects are obtained. Further, types of the element M2 are not particularly limited, as long as the types of the element M2 are any one or more of the foregoing Mg and the like. In particular, the element M2 may be preferably Mg, S, F, Al, P, C, or Ni, may be more preferably Mg or C, and may be further preferably Mg, since thereby, higher effects are obtained.

A value of the mole fraction R1 is not particularly limited, as long as the mole fraction R1 on the central side of the lithium-containing compound is smaller than that on the surface layer side of the lithium-containing compound as described above. In particular, in the case where the mole fraction R1 is gradually decreased from the surface layer side of the lithium-containing compound to the central side of the lithium-containing compound, the mole fraction R1 may be preferably from 0.2 to 0.8 both inclusive where a mass ratio R2(%) represented by the following Formula (3) is from 0.05% to 0.1% both inclusive. One reason for this is that, in this case, the value of the mole fraction R1 becomes appropriate, and therefore, higher effects are obtained.

R2(%)=(a sum of masses of Mn, Co, Ni, and the element M2/an entire mass of the lithium-containing compound)×100 (3)

As seen in the fact that the mole fraction R1 on the central side is smaller than that on the surface layer side, the mass ratio R2 is an index indicating a position in a direction (a depth direction) from the uppermost surface to the center out of the surface layer region of the lithium-containing compound. That is, in the case where the mole fraction R1 indicating the ratio of the substance quantity of the element M2 with respect to the substance quantities of the main constituent elements is gradually decreased from the surface layer side to the central side, the mass ratio R2 indicating the ratio of the masses of the main constituent elements with respect to the entire mass is also gradually decreased in the same direction. Therefore, since the mass ratio R2 is gradually decreased from the surface layer side to the central side in the surface layer region of the lithium-containing compound, a specific location (depth from the uppermost surface) inside the lithium-containing compound is allowed to be specified by specifying a value of the mass ratio R2.

Calculation procedure of the mole fraction R1 and the mass ratio R2 may be, for example, as follows. First, 0.2 g of the lithium-containing compound is added with 10 ml (=10 cm³) of a buffer solution (pH=5), and the resultant is stirred. Thereafter, respective portions of the solution that are collected every minute from the time after one minute elapses to the time after twenty minutes elapse are filtrated by a filter of 0.2 μm. Subsequently, the substance quantities (mole numbers) of Mn, Co, Ni, and the element M2 in the respective portions of the solution were measured with the use of an ICP method to obtain the mole fraction R1 with respect to a dissolution amount. In this case, it is assumed that the particle shape of the lithium-containing compound is spherical. The particle is deformed in a similarity state by dissolution while remaining spherical, and thereby, the radius thereof is decreased. The term “dissolution amount” refers to the ratio (wt %) of the sum of the masses of the main constituent elements (Mn, Co, Ni, and the element M2) with respect to the entire mass of the lithium-containing compound, that is, the foregoing mass ratio R2.

It is assumed here that, out of the lithium-containing compound, the abundance of the element M2 in a portion having the dissolution amount of about 0% to about 0.1% both inclusive (a portion with the depth of about 10 nm to about 100 nm both inclusive from the surface layer) largely affects property of the cathode active material. Therefore, attention is focused on the mole fraction R1 in a portion having the mass ratio R2 of 0.05% to 0.1% both inclusive where the foregoing affect is predicted to be particularly large.

Though the content of the element M2 in the lithium-containing compound is not particularly limited, in particular, the content of the element M2 may be preferably small sufficiently with respect to the content of Li. One reason for this is that, when the amount of the element M2 existing in the surface region of the lithium-containing compound is excessively large, insertion and extraction of lithium ions may be inhibited, and the battery capacity may be lowered. In particular, the content of the element M2 may be preferably from 0.01 mol % to 5 mol % both inclusive with respect to the content of Li, since thereby, a sufficient battery capacity is obtained, while the preventive function by the surface layer region is maintained.

It is to be noted that the lithium-containing compound may be obtained, for example, by using the composite oxide shown in Formula (1) and the M2-containing compound as raw materials, covering the surface of the composite oxide with the M2-containing compound by a mechanochemical reaction, and firing the resultant. In the lithium-containing compound, the M2-containing compound may preferably form a solid solution with the composite oxide. Further, at least part of the element M2 may be preferably substituted by part of Li existing excessively (lithium rich) in the crystal structure in the surface layer region of the composite oxide, since thereby, the crystal structure of the lithium-containing compound is stabilized, and therefore, higher effects are obtained. However, part of the element M2 may be substituted by an element other than Li. It is to be noted that type of the M2-containing compound is not particularly limited, and may be, for example, an oxide, a hydroxide, a phosphorus oxide, or the like.

[Analytical Method of Cathode Active Material]

For checking the composition of the cathode active material, the lithium-containing compound may be analyzed with the use of various element analytical methods. Examples of the element analytical methods may include X-ray diffraction (XRD) method, time-of-flight secondary ion mass spectrometry (TOF-SIMS) method, high-frequency induction coupled plasma (ICP) emission spectrometry method, Raman spectrometric method, and an energy dispersive X-ray spectrometric method (EDX). In this case, analysis may be made after dissolving the surface region of the lithium-containing compound with the use of an acid or the like.

In particular, since the element M2 is inserted in the crystal structure of the composite oxide, the XRD method may be preferably used for examining whether or not the element M2 forms part of the crystal structure, the existence range of the element M2 in the composite oxide, and the like.

It is to be noted that in a region where charge and discharge are performed in a secondary battery (in a region where a cathode is opposed to an anode), the crystal structure of the lithium-containing compound may be changed due to a charge-discharge reaction. Therefore, even when the crystal structure of the lithium-containing compound is analyzed with the use of the X-ray diffraction method or the like after charge and discharge, it is possible that the initial crystal structure (before charge and discharge) is not allowed to be checked. However, in the case where a region (a non-charge-discharge region) where charge and discharge are not performed exists in the cathode, the crystal structure may be preferably examined in the non-charge-discharge region. In the non-charge-discharge region, the crystal structure before charge and discharge is retained, and therefore, the crystal structure is allowed to be analyzed subsequently without relation to presence or absence of charge and discharge. In the foregoing “non-charge-discharge region,” for example, for the purpose of securing safety, an insulating protective tape may be bonded to an end surface of the cathode (the cathode active material layer). Therefore, the non-charge-discharge region is a region where charge and discharge are not allowed to be performed due to existence of the insulating protective tape.

For examining the content of the element M2 in the lithium-containing compound, the lithium-containing compound may be analyzed with the use, for example, of ICP emission spectrometry method, TOF-SIMS method, EDX method, and/or the like. In this case, the non-charge-discharge region of the cathode may be preferably analyzed as well.

Procedure in the case of using the ICP emission spectrometry method may be, for example, as follows. First, lithium-containing compound particles are added with a buffer solution, and the resultant is stirred. Subsequently, respective portions of the buffer solution in which the surfaces of the lithium-containing compound particles are dissolved are collected every predetermined time, and the collected portions are filtrated. Subsequently, the masses of Li and the element M2 in the respective portions of the buffer solution that have been collected every predetermined time are measured with the use of ICP emission spectrometry method. Finally, the substance quantities (mol) of Li and the element M2 are calculated from the measured masses to obtain the mole ratio (mol %) of the element M2 with respect to Li.

[Method of Using Cathode Active Material]

Upon charging and discharging a secondary battery using the cathode active material, a charging voltage (cathode electric potential: standard electric potential to lithium metal) at the time of the initial charge may be preferably high, and more specifically, may be preferably equal to or more than 4.4 V. One reason for this is that, in this case, a sufficient amount of lithium ions is extracted from the cathode active material at the time of the initial charge, and therefore, a generation reaction of an irreversible capacity is allowed to be substantially completed in an anode. However, in order to suppress a decomposition reaction of the cathode active material, it may be preferable that the charging voltage at the time of the initial charge be not extremely high, and more specifically, be equal to or less than 4.6 V.

It is to be noted that a charging voltage (cathode electric potential: standard electric potential to lithium metal) at the time of charge after the initial charge is not particularly limited. However, in particular, such a charging voltage may be preferably lower than the charging voltage at the time of the initial charge, and more specifically, may be preferably around 4.3 V. One reason for this is that, in this case, lithium ions are smoothly extracted from the cathode active material for obtaining a battery capacity, and a decomposition reaction of an electrolytic solution, a dissolution reaction of a separator, and the like are suppressed.

[Function and Effect of Cathode Active Material]

According to the cathode active material, the element M2 is inserted in the crystal structure of the surface layer region of the composite oxide shown in Formula (1), and the mole fraction R1 shown in Formula (2) on the central side is smaller than that on the surface layer side. In this case, as described above, first, when a secondary battery using the cathode active material is initially charged at a high voltage, a generation reaction of an irreversible capacity is substantially completed in an anode. Therefore, a high battery capacity is stably obtained at the time of charge and discharge after the initial charge and discharge. Secondly, at the time of charge and discharge, the central portion (the inner portion) of the lithium-containing compound is protected from an electrolytic solution and the like by the surface layer region (the outer portion) at the time of charge and discharge, and insertion and extraction of ions are not inhibited in the surface layer region. Therefore, even when charge and discharge are repeatedly performed, the discharge capacity is less likely to be lowered, and gas (such as oxygen gas) is less likely to be generated by a decomposition reaction of the composite oxide. Thirdly, the distribution of the element M2 in the surface layer region becomes appropriate. Therefore, while advantages resulting from existence of the element M2 are exploited, resistance increase is suppressed. Therefore, battery characteristics of the secondary battery using the cathode active material are allowed to be improved.

In particular, in the case where the mole fraction R1 is gradually decreased from the surface layer side to the central side, and the mole fraction R1 is from 0.2 to 0.8 both inclusive where a mass ratio R2 shown in Formula (3) is from 0.05% to 0.1% both inclusive, higher effects are obtainable. Further, in the case where the content of the element M2 in the lithium-containing compound is from 0.01 mol % to 5 mol % both inclusive with respect to the content of Li, higher effects are obtainable. Further, in the case where a in Formula (1) satisfies 0.1<a<0.25, higher effects are obtainable.

### 2. Application Examples of Cathode Active Material

### Lithium Secondary Batteries

Next, a description will be given of application examples of the foregoing cathode active material. The cathode active material may be used, for example, for a cathode of a lithium secondary battery.

[2-1. Cathode and Lithium Ion Secondary Battery (Cylindrical Type)]

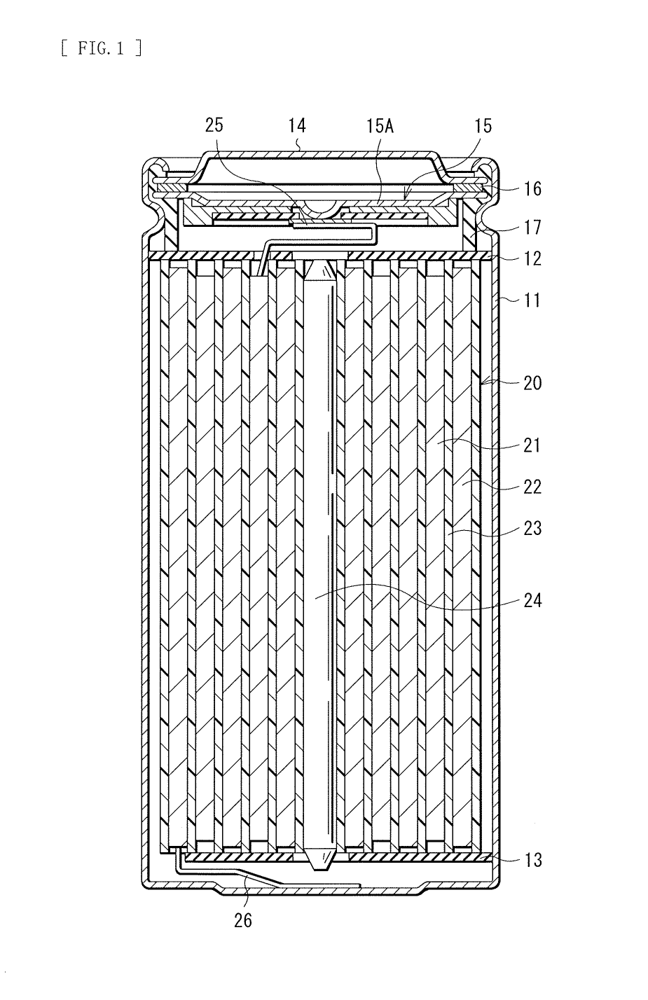

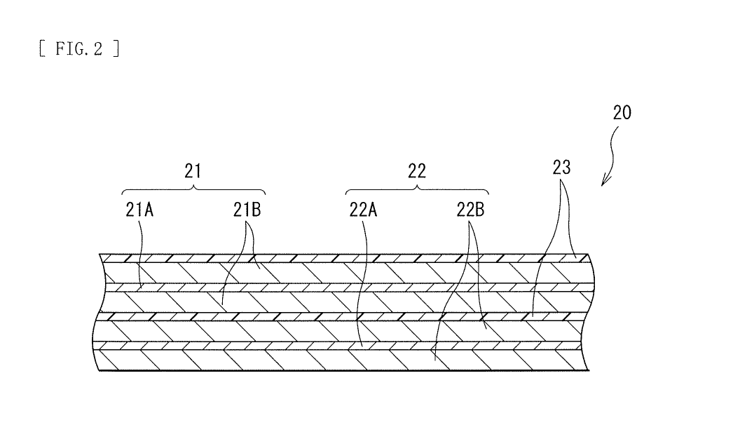

FIG. 1 and FIG. 2 illustrate cross-sectional configurations of a secondary battery. FIG. 2 illustrates enlarged part of a spirally wound electrode body 20 illustrated in FIG. 1.

[Whole Configuration of Secondary Battery]

The secondary battery herein described is a lithium ion secondary battery in which the capacity of an anode 22 is obtained by insertion and extraction of Li (lithium ions) as an electrode reactant.

The secondary battery may be, for example, a so-called cylindrical-type secondary battery. The spirally wound electrode body 20 and a pair of insulating plates 12 and 13 are contained inside a battery can 11 in the shape of a substantially hollow cylinder. The spirally wound electrode body 20 may be obtained, for example, by laminating a cathode 21 and the anode 22 with a separator 23 in between and spirally winding the resultant laminated body.

The battery can 11 has a hollow structure in which one end of the battery can 11 is closed and the other end of the battery can 11 is opened. The battery can 11 may be made, for example, of iron, aluminum, an alloy thereof, or the like. It is to be noted that the surface of the battery can 11 may be plated with nickel or the like. The pair of insulating plates 12 and 13 is arranged to sandwich the spirally wound electrode body 20 in between, and to extend perpendicularly to the spirally wound periphery surface.

At the open end of the battery can 11, a battery cover 14, a safety valve mechanism 15, and a positive temperature coefficient device (PTC device) 16 are attached by being swaged with a gasket 17. Thereby, the battery can 11 is hermetically sealed. The battery cover 14 may be made, for example, of a material similar to that of the battery can 11. The safety valve mechanism 15 and the PTC device 16 are provided inside the battery cover 14. The safety valve mechanism 15 is electrically connected to the battery cover 14 through the PTC device 16. In the safety valve mechanism 15, in the case where the internal pressure becomes a certain level or more by internal short circuit, external heating, or the like, a disk plate 15A inverts to cut electric connection between the battery cover 14 and the spirally wound electrode body 20. The PTC device 16 prevents abnormal heat generation resulting from a large current. As temperature rises, resistance of the PTC device 16 is increased accordingly. The gasket 17 may be made, for example, of an insulating material. The surface of the gasket 17 may be coated with asphalt.

In the center of the spirally wound electrode body 20, for example, a center pin 24 may be inserted. However, the center pin 24 is not necessarily included therein. For example, a cathode lead 25 made of an electrically-conductive material such as aluminum may be connected to the cathode 21. For example, an anode lead 26 made of an electrically-conductive material such as nickel may be connected to the anode 22. The cathode lead 25 is attached to the safety valve mechanism 15 by welding or the like, and is electrically connected to the battery cover 14. The anode lead 26 is attached to the battery can 11 by welding or the like, and is electrically connected to the battery can 11.

[Cathode]

The cathode 21 has a cathode active material layer 21B on a single surface or both surfaces of a cathode current collector 21A. The cathode current collector 21A may be made, for example, of an electrically-conductive material such as aluminum, nickel, and stainless steel. The cathode active material layer 21B contains the foregoing cathode active material, and may contain other materials such as a cathode binder and a cathode electric conductor as necessary.

Examples of the cathode binder may include any one or more of synthetic rubbers, polymer materials, and the like. Examples of the synthetic rubber may include a styrene-butadiene-based rubber, a fluorine-based rubber, and ethylene propylene diene. Examples of the polymer material may include polyvinylidene fluoride and polyimide.

Examples of the cathode electric conductor may include any one or more of carbon materials and the like. Examples of the carbon materials may include graphite, carbon black, acetylene black, and Ketjen black. The cathode electric conductor may be a metal material, an electrically-conductive polymer, or the like as long as the material has electric conductivity.

It is to be noted that the cathode active material layer 21B may further contain other types of cathode active materials as long as the cathode active material layer 21B contains the foregoing lithium-containing compound as a cathode active material. Examples of such other types of cathode materials may include lithium-containing compounds such as a lithium-transition-metal composite oxide and a lithium-transition-metal-phosphate compound (excluding a compound corresponding to the foregoing lithium-containing compound). The lithium-transition-metal composite oxide is an oxide containing Li and one or more transition metal elements as constituent elements. The lithium-transition-metal-phosphate compound is a phosphate compound containing Li and one or more transition metal elements as constituent elements. Examples of the lithium-transition-metal composite oxide may include LiCoO₂, LiNiO₂, and a lithium-nickel-based composite oxide represented by the following Formula (20). Examples of the lithium-transition-metal-phosphate compound may include LiFePO₄ and LiFe₁₋ᵤMnᵤPO₄ (u<1). Thereby, a high battery capacity is obtained, and superior cycle characteristics are obtained.

LiNi_{1-z}M_{z}O₂ (20)

(In Formula (20), M is at least one of Co, Mn, Fe, Al, V, Sn, Mg, Ti, Sr, Ca, Zr, Mo, Tc, Ru, Ta, W, Re, Yb, Cu, Zn, Ba, B, Cr, Si, Ga, P, Sb, and Nb; and z satisfies 0.005<z<0.5.)

In addition thereto, the cathode active material may be, for example, an oxide, a disulfide, a chalcogenide, an electrically-conductive polymer, or the like. Examples of the oxide may include titanium oxide, vanadium oxide, and manganese dioxide. Examples of the disulfide may include titanium disulfide and molybdenum sulfide. Examples of the chalcogenide may include niobium selenide. Examples of the electrically-conductive polymer may include sulfur, polyaniline, and polythiophene. However, the cathode material is not limited to the foregoing materials.

[Anode]

The anode 22 has an anode active material layer 22B on a single surface or both surfaces of an anode current collector 22A.

The anode current collector 22A may be made, for example, of an electrically-conductive material such as copper, nickel, and stainless steel. The surface of the anode current collector 22A may be preferably roughened. Thereby, due to a so-called anchor effect, adhesion characteristics of the anode active material layer 22B with respect to the anode current collector 22A are improved. In this case, it is enough that the surface of the anode current collector 22A in a region opposed to the anode active material layer 22B is roughened at minimum. Examples of roughening methods may include a method of forming fine particles by utilizing electrolytic treatment. The electrolytic treatment is a method of forming the fine particles on the surface of the anode current collector 22A with the use of an electrolytic method in an electrolytic bath to provide concavity and convexity on the surface of the anode current collector 22A. A copper foil fabricated by an electrolytic method is generally called “electrolytic copper foil.”

The anode active material layer 22B contains any one or more of anode materials capable of inserting and extracting lithium ions as anode active materials. The anode active material layer 22B may further contain other materials such as an anode binder and an anode electric conductor as necessary. Details of the anode binder and the anode electric conductor may be, for example, similar to those of the cathode binder and the cathode electric conductor. However, the chargeable capacity of the anode material may be preferably larger than the discharge capacity of the cathode 21 in order to prevent lithium metal from being unintentionally precipitated on the anode 22 in the middle of charge. That is, the electrochemical equivalent of the anode material capable of inserting and extracting lithium ions may be preferably larger than the electrochemical equivalent of the cathode 21.

Examples of the anode material may include carbon materials. In the carbon material, its crystal structure change at the time of insertion and extraction of lithium ions is extremely small, and therefore, the carbon material provides high energy density and superior cycle characteristics. Further, the carbon material serves as an anode electric conductor as well. Examples of the carbon material may include graphitizable carbon, non-graphitizable carbon having spacing of (002) plane equal to or greater than 0.37 nm, and graphite having spacing of (002) plane equal to or smaller than 0.34 nm. More specifically, examples of the carbon material may include pyrolytic carbons, cokes, glassy carbon fiber, an organic polymer compound fired body, activated carbon, and carbon blacks. Examples of the cokes may include pitch coke, needle coke, and petroleum coke. The organic polymer compound fired body is obtained by firing (carbonizing) a polymer compound such as a phenol resin and a furan resin at appropriate temperature. In addition thereto, the carbon material may be low crystalline carbon or amorphous carbon heat-treated at temperature of about 1000 deg C. or less. It is to be noted that the shape of the carbon material may be any of a fibrous shape, a spherical shape, a granular shape, and a scale-like shape.

Further, the anode material may be, for example, a material (a metal-based material) containing any one or more of metal elements and metalloid elements as constituent elements, since higher energy density is thereby obtained. Such a metal-based material may be a simple substance, an alloy, or a compound, may be two or more thereof, or may have one or more phases thereof in at least part thereof. It is to be noted that “alloy” includes a material containing one or more metal elements and one or more metalloid elements, in addition to a material configured of two or more metal elements. Further, the “alloy” may contain a nonmetallic element. Examples of the structure thereof may include a solid solution, a eutectic crystal (eutectic mixture), an intermetallic compound, and a structure in which two or more thereof coexist.

Examples of the foregoing metal elements and the foregoing metalloid elements may include any one or more of metal elements and metalloid elements capable of forming an alloy with Li. Specific examples thereof may include Mg, B, Al, Ga, In, Si, Ge, Sn, Pb, Bi, Cd, Ag, Zn, Hf, Zr, Y, Pd, and Pt. In particular, at least one of Si and Sn may be preferable. One reason for this is that Si and Sn have a superior ability of inserting and extracting lithium ions, and therefore, provide high energy density.

A material containing at least one of Si and Sn as constituent elements may be one of a simple substance, an alloy, and a compound of Si, may be one of a simple substance, an alloy, and a compound of Sn, may be two or more thereof, or may have one or more phases thereof in at least part thereof. It is to be noted that the simple substance merely refers to a general simple substance (a small amount of impurity may be therein contained), and does not necessarily refer to a purity 100% simple substance.

The alloys of Si may contain, for example, any one or more of elements such as Sn, Ni, Cu, Fe, Co, Mn, Zn, In, Ag, Ti, Ge, Bi, Sb, and Cr as constituent elements other than Si. The compounds of Si may contain, for example, any one or more of C, O, and the like as constituent elements other than Si. It is to be noted that, for example, the compounds of Si may contain any one or more of the elements described for the alloys of Si as constituent elements other than Si.

Examples of the alloys of Si and the compounds of Si may include SiB₄, SiB₆, Mg₂Si, Ni₂Si, TiSi₂, MoSi₂, CoSi₂, NiSi₂, CaSi₂, CrSi₂, Cu₅Si, FeSi₂, MnSi₂, NbSi₂, TaSi₂, VSi₂, WSi₂, ZnSi₂, SiC, Si₃N₄, Si₂N₂O, SiOᵥ (0<v≦2), and LiSiO. It is to be noted that v in SiOᵥ may be in the range of 0.2<v<1.4.

The alloys of Sn may contain, for example, any one or more of elements such as Si, Ni, Cu, Fe, Co, Mn, Zn, In, Ag, Ti, Ge, Bi, Sb, and Cr as constituent elements other than Sn. The compounds of Sn may contain, for example, any one or more of elements such as C and O as constituent elements other than Sn. It is to be noted that the compounds of Sn may contain, for example, any one or more of elements described for the alloys of Sn as constituent elements other than Sn. Examples of the alloys of Sn and the compounds of Sn may include SnO_{w} (0<w≦2), SnSiO₃, LiSnO, and Mg₂Sn.

Further, as a material containing Sn, for example, a material containing a second constituent element and a third constituent element in addition to Sn as a first constituent element may be preferable. Examples of the second constituent element may include any one or more of elements such as Co, Fe, Mg, Ti, V, Cr, Mn, Ni, Cu, Zn, Ga, Zr, Nb, Mo, Ag, In, Ce, Hf, Ta, W, Bi, and Si. Examples of the third constituent element may include any one or more of B, C, Al, P, and the like. In the case where the second constituent element and the third constituent element are contained, a high battery capacity, superior cycle characteristics, and the like are obtained.

In particular, a material (an SnCoC-containing material) containing Sn, Co, and C as constituent elements may be preferable. The composition of the SnCoC-containing material may be, for example, as follows. That is, the C content may be from 9.9 mass % to 29.7 mass % both inclusive, and the ratio of contents of Sn and Co (Co/(Sn+Co)) may be from 20 mass % to 70 mass % both inclusive, since high energy density is obtained thereby.

It may be preferable that the SnCoC-containing material have a phase containing Sn, Co, and C. Such a phase may be preferably low-crystalline or amorphous. The phase is a reaction phase capable of reacting with Li. Due to existence of the reaction phase, superior characteristics are obtained. The half bandwidth of the diffraction peak obtained by X-ray diffraction of the phase may be preferably equal to or greater than 1 deg based on diffraction angle of 20 in the case where CuKα ray is used as a specific X ray, and the insertion rate is 1 deg/min. Thereby, lithium ions are more smoothly inserted and extracted, and reactivity with the electrolytic solution is decreased. It is to be noted that, in some cases, the SnCoC-containing material includes a phase containing a simple substance or part of the respective constituent elements in addition to the low-crystalline phase or the amorphous phase.

Whether or not the diffraction peak obtained by the X-ray diffraction corresponds to the reaction phase capable of reacting with Li is allowed to be easily determined by comparison between X-ray diffraction charts before and after electrochemical reaction with Li. For example, if the position of the diffraction peak after electrochemical reaction with Li is changed from the position of the diffraction peak before the electrochemical reaction with Li, the obtained diffraction peak corresponds to the reaction phase capable of reacting with Li. In this case, for example, the diffraction peak of the low crystalline reaction phase or the amorphous reaction phase is seen in the range of 2θ=from 20 deg to 50 deg both inclusive. Such a reaction phase may have, for example, the foregoing respective constituent elements, and the low crystalline or amorphous structure thereof possibly results from existence of C mainly.

In the SnCoC-containing material, part or all of C as a constituent element may be preferably bonded to a metal element or a metalloid element as other constituent element, since cohesion or crystallization of Sn and/or the like is suppressed thereby. The bonding state of elements is allowed to be checked, for example, by an X-ray photoelectron spectroscopy method (XPS). In a commercially available device, for example, as a soft X ray, Al—Kα ray, Mg—Kα ray, or the like may be used. In the case where at least part of C is bonded to a metal element, a metalloid element, or the like, the peak of a synthetic wave of is orbit of C (C1s) is shown in a region lower than 284.5 eV. It is to be noted that in the device, energy calibration is made so that the peak of 4f orbit of Au atom (Au4f) is obtained in 84.0 eV. At this time, in general, since surface contamination carbon exists on the material surface, the peak of C1s of the surface contamination carbon is regarded as 284.8 eV, which is used as the energy standard. In XPS measurement, the waveform of the peak of C1s is obtained as a form including the peak of the surface contamination carbon and the peak of carbon in the SnCoC-containing material. Therefore, for example, analysis may be made with the use of commercially-available software to isolate both peaks from each other. In the waveform analysis, the position of the main peak existing on the lowest bound energy side is the energy standard (284.8 eV).

It is to be noted that the SnCoC-containing material is not limited to the material (SnCoC) formed of only Sn, Co, and C as constituent elements. That is, the SnCoC-containing material may further contain, for example, any one or more of Si, Fe, Ni, Cr, In, Nb, Ge, Ti, Mo, Al, P, Ga, Bi, and the like as constituent elements as necessary.

In addition to the SnCoC-containing material, a material (an SnCoFeC-containing material) containing Sn, Co, Fe, and C as constituent elements may be also preferable. The composition of the SnCoFeC-containing material may be any composition. For example, the composition in which the Fe content is set small may be as follows. That is, the C content may be from 9.9 mass % to 29.7 mass % both inclusive, the Fe content may be from 0.3 mass % to 5.9 mass % both inclusive, and the ratio of contents of Sn and Co (Co/(Sn+Co)) may be from 30 mass % to 70 mass % both inclusive. Further, the composition in which the Fe content is set large is as follows. That is, the C content is from 11.9 mass % to 29.7 mass % both inclusive, the ratio of contents of Sn, Co, and Fe ((Co+Fe)/(Sn+Co+Fe)) is from 26.4 mass % to 48.5 mass % both inclusive, and the ratio of contents of Co and Fe (Co/(Co+Fe)) is from 9.9 mass % to 79.5 mass % both inclusive. In such a composition range, high energy density is obtained. Physicality (such as half bandwidth) of the SnCoFeC-containing material is similar to that of the foregoing SnCoC-containing material.

In addition thereto, the anode material may be, for example, a metal oxide, a polymer compound, or the like. Examples of the metal oxide may include iron oxide, ruthenium oxide, and molybdenum oxide. Examples of the polymer compound may include polyacetylene, polyaniline, and polypyrrole.

The anode active material layer 22B may be formed, for example, by a coating method, a vapor-phase deposition method, a liquid-phase deposition method, a spraying method, a firing method (a sintering method), or two or more methods thereof. The coating method may be a method in which, for example, after a particulate (powder) anode active material is mixed with an anode binder and/or the like, the mixture is dispersed in a solvent such as an organic solvent, and the anode current collector 22A is coated with the resultant. Examples of the vapor-phase deposition method may include a physical deposition method and a chemical deposition method. More specifically, examples thereof may include a vacuum evaporation method, a sputtering method, an ion plating method, a laser ablation method, a thermal chemical vapor deposition method, a chemical vapor deposition (CVD) method, and a plasma chemical vapor deposition method. Examples of the liquid-phase deposition method may include an electrolytic plating method and an electroless plating method. The spraying method is a method in which an anode active material in a fused state or a semi-fused state is sprayed to the anode current collector 22A. The firing method may be, for example, a method in which after the anode current collector 22A is coated with the use of a coating method, heat treatment is performed at temperature higher than the melting point of the anode binder and/or the like. As the firing method, for example, a known method such as an atmosphere firing method, a reactive firing method, and a hot press firing method may be used.

In the secondary battery, as described above, in order to prevent lithium metal from being unintentionally precipitated on the anode 22 in the middle of charge, the electrochemical equivalent of the anode material capable of inserting and extracting lithium ions may be preferably larger than the electrochemical equivalent of the cathode. Further, in the case where the open circuit voltage (that is, a battery voltage) at the time of completely-charged state is equal to or greater than 4.25 V, the extraction amount of lithium ions per unit mass is larger than that in the case where the open circuit voltage is 4.2 V even if the same cathode active material is used. Therefore, amounts of the cathode active material and the anode active material are adjusted accordingly. Thereby, high energy density is obtainable.

[Separator]

The separator 23 separates the cathode 21 from the anode 22, and passes lithium ions while preventing current short circuit resulting from contact of both electrodes. The separator 23 may be, for example, a porous film made of a synthetic resin, ceramics, or the like. The separator 23 may be a laminated film in which two or more types of porous films are laminated. Examples of the synthetic resin may include polytetrafluoroethylene, polypropylene, and polyethylene.

In particular, the separator 23 may include, for example, the foregoing porous film (base material layer) and a polymer compound layer provided on one surface or both surfaces of the base material layer. One reason for this is that, thereby, adhesibility of the separator 23 with respect to the cathode 21 and the anode 22 is improved, and therefore, skewness of the spirally wound electrode body 20 is suppressed. Thereby, a decomposition reaction of the electrolytic solution is suppressed, and liquid leakage of the electrolytic solution with which the base material layer is impregnated is suppressed. Accordingly, even if charge and discharge are repeated, the resistance is less likely to be increased, and battery swollenness is suppressed.

The polymer compound layer may contain, for example, a polymer material such as polyvinylidene fluoride, since such a polymer material has superior physical strength and is electrochemically stable. However, the polymer material may be a material other than polyvinylidene fluoride. Upon forming the polymer compound layer, for example, after a solution in which the polymer material is dissolved is prepared, the base material layer is coated with the solution, and the solution is subsequently dried. Alternatively, the base material layer may be soaked in the solution and the solution may be subsequently dried.

[Electrolytic Solution]

The separator 23 is impregnated with an electrolytic solution as a liquid electrolyte. The electrolytic solution contains a solvent and an electrolyte salt, and may further contain other material such as an additive as necessary.

The solvent contains any one or more of nonaqueous solvents such as an organic solvent. Examples of the nonaqueous solvents may include a cyclic ester carbonate, a chain ester carbonate, lactone, a chain carboxylic ester, and nitrile, since a superior battery capacity, superior cycle characteristics, superior conservation characteristics, and the like are thereby obtained. Examples of the cyclic ester carbonate may include ethylene carbonate, propylene carbonate, and butylene carbonate. Examples of the chain ester carbonate may include dimethyl carbonate, diethyl carbonate, ethyl methyl carbonate, and methylpropyl carbonate. Examples of the lactone may include γ-butyrolactone and γ-valerolactone. Examples of the carboxylic ester may include methyl acetate, ethyl acetate, methyl propionate, ethyl propionate, methyl butyrate, methyl isobutyrate, methyl trimethylacetate, and ethyl trimethylacetate. Examples of the nitrile may include acetonitrile, glutaronitrile, adiponitrile, methoxyacetonitrile, and 3-methoxypropionitrile.

In addition thereto, the nonaqueous solvent may be, for example, 1,2-dimethoxyethane, tetrahydrofuran, 2-methyltetrahydrofuran, tetrahydropyran, 1,3-dioxolane, 4-methyl-1,3-dioxolane, 1,3-dioxane, 1,4-dioxane, N,N-dimethylformamide, N-methylpyrrolidinone, N-methyloxazolidinone, N,N′-dimethylimidazolidinone, nitromethane, nitroethane, sulfolane, trimethyl phosphate, or dimethyl sulfoxide, since thereby, a similar advantage is obtained.

In particular, at least one or of ethylene carbonate, propylene carbonate, dimethyl carbonate, diethyl carbonate, and ethyl methyl carbonate may be preferable, since a further superior battery capacity, further superior cycle characteristics, further superior conservation characteristics, and the like are thereby obtained. In this case, a combination of a high viscosity (high dielectric constant) solvent (for example, specific dielectric constant ∈≧30) such as ethylene carbonate and propylene carbonate and a low viscosity solvent (for example, viscosity≦1 mPa·s) such as dimethyl carbonate, ethylmethyl carbonate, and diethyl carbonate may be more preferable. One reason for this is that the dissociation property of the electrolyte salt and ion mobility are thereby improved.

In particular, the solvent may preferably contain any one or more of unsaturated cyclic ester carbonates. One reason for this is that a stable protective film is formed mainly on the surface of the anode 14 at the time of charge and discharge, and therefore, a decomposition reaction of the electrolytic solution is suppressed. The unsaturated cyclic ester carbonate is a cyclic ester carbonate having one or more unsaturated carbon bonds (carbon-carbon bonds). Specific examples of the unsaturated cyclic ester carbonate may include vinylene carbonate, vinylethylene carbonate, and methyleneethylene carbonate. The unsaturated cyclic ester carbonate may be a compound other than the foregoing compounds. The content of the unsaturated cyclic ester carbonate in the solvent is not particularly limited, and may be, for example, from 0.01 wt % to 10 wt % both inclusive.

Further, the solvent may preferably contain any one or more of halogenated ester carbonates. One reason for this is that a stable protective film is formed mainly on the surface of the anode 14 at the time of charge and discharge, and therefore, a decomposition reaction of the electrolytic solution is suppressed. The halogenated ester carbonate is a cyclic ester carbonate having one or more halogens as constituent elements or a chain ester carbonate having one or more halogens as constituent elements. Examples of the cyclic halogenated ester carbonate may include 4-fluoro-1,3-dioxolane-2-one and 4,5-difluoro-1,3-dioxolane-2-one. Examples of the chain halogenated ester carbonate may include fluoromethyl methyl carbonate, bis(fluoromethyl)carbonate, and difluoromethyl methyl carbonate. However, specific examples of the halogenated ester carbonate may include a compound other than the foregoing compounds. Although the content of the halogenated ester carbonate in the solvent is not particularly limited, the content thereof may be, for example, from 0.01 wt % to 50 wt % both inclusive.

Further, the solvent may preferably contain sultone (cyclic sulfonic ester), since the chemical stability of the electrolytic solution is further improved thereby. Examples of such sultone may include propane sultone and propene sultone. Examples thereof may include a compound other than the foregoing compounds. Although the sultone content in the solvent is not particularly limited, for example, the sultone content may be from 0.5 wt % to 5 wt % both inclusive.

Further, the solvent may preferably contain an acid anhydride since the chemical stability of the electrolytic solution is thereby further improved. Examples of the acid anhydrides may include a carboxylic anhydride, a disulfonic anhydride, and a carboxylic acid sulfonic acid anhydride. Examples of the carboxylic anhydride may include a succinic anhydride, a glutaric anhydride, and a maleic anhydride. Examples of the disulfonic anhydride may include an ethane disulfonic anhydride and a propane disulfonic anhydride. Examples of the carboxylic acid sulfonic acid anhydride may include a sulfobenzoic anhydride, a sulfopropionic anhydride, and a sulfobutyric anhydride. However, specific examples of the acid anhydrides may include a compound other than the foregoing compounds. Although the content of the acid anhydride in the solvent is not particularly limited, for example, the content thereof may be from 0.5 wt % to 5 wt % both inclusive.

The electrolyte salt may include, for example, any one or more of salts such as a lithium salt. However, the electrolyte salt may include, for example, a salt other than the lithium salt (such as a light metal salt other than the lithium salt).

Examples of the lithium salts may include lithium hexafluorophosphate (LiPF₆), lithium tetrafluoroborate (LiBF₄), lithium perchlorate (LiClO₄), lithium hexafluoroarsenate (LiAsF₆), lithium tetraphenylborate (LiB(C₆H₅)₄), lithium methanesulfonate (LiCH₃SO₃), lithium trifluoromethane sulfonate (LiCF₃SO₃), lithium tetrachloroaluminate (LiAlCl₄), dilithium hexafluorosilicate (Li₂SiF₆), lithium chloride (LiCl), and lithium bromide (LiBr). Examples thereof may include a compound other than the foregoing compounds. Thereby, a superior battery capacity, superior cycle characteristics, superior conservation characteristics, and the like are obtained.

In particular, at least one of LiPF₆, LiBF₄, LiClO₄, and LiAsF₆ may be preferable, and LiPF₆ may be more preferable, since the internal resistance is thereby lowered, and therefore, a higher effect is obtained.

Although the content of the electrolyte salt is not particularly limited, in particular, the content thereof may be preferably from 0.3 mol/kg to 3.0 mol/kg both inclusive with respect to the solvent, since thereby, high ion conductivity is obtained.

It is to be noted that at least one of the cathode 21 (the cathode active material layer 21B), the anode 22 (the anode active material layer 22B), and the electrolytic solution may preferably contain at least one of a heteropoly acid as a condensate of two or more oxo acids and a heteropoly acid compound, since thereby, a coat (an SEI film) is formed on the surface of the electrodes at the time of initial charge. The coat derived from the heteropoly acid compound capable of inserting and extracting lithium ions has superior lithium ion permeability. Therefore, while a reaction between the electrodes and the electrolytic solution is suppressed, generation of gas (such as oxygen gas) (in particular, in high-temperature environment) resulting from a decomposition reaction of the cathode active material and/or the like is allowed to be suppressed without lowering cycle characteristics. Further, due to an oxygen gas-derived residual product, unnecessary airspaces are less likely to be formed, for example, in the cathode active material layer 21B.

Each of the heteropoly acid compound and the heteropoly acid configuring the heteropoly acid compound is a compound containing polyatoms selected from the following element group (a), or a compound containing polyatoms selected from the element group (a) in which part of the polyatoms is substituted by at least one element selected from element group (b).

Element group (a): Mo, W, Nb, and V

Element group (b): Ti, Cr, Mn, Fe, Co, Ni, Cu, Zn, Ga, Zr, Tc, Rh, Cd, In, Sn, Ta, Re, Tl, and Pb

Further, each of the heteropoly acid compound and the heteropoly acid is a compound containing heteroatoms selected from the following element group (c), or a compound containing heteroatoms selected from the following element group (c) in which part of the heteroatoms is substituted by at least one element selected from element group (d).

Element group (c): B, Al, Si, P, Cr, Mn, Fe, Co, Ni, Cu, Zn, Ge, and As

Element group (d): H, Be, B, C, Na, Al, Si, P, S, Ti, V, Cr, Mn, Fe, Co, Ni, Cu, Zn, Ga, Ge, As, Se, Zr, Rh, Sn, Sb, Te, I, Re, Pt, Bi, Ce, Th, U, and Np

Specific examples of the heteropoly acid contained in the heteropoly acid compound may include heteropolytungstate such as tungstophosphoric acid and tungstosilicic acid, and heteropolymolybdate such as phosphomolybdic acid and silicomolybdic acid. Further, examples of materials containing a plurality of poly elements may include molybdo-vanadophosphoric acid, molybdo-tungstophosphoric acid, molybdo-vanadosilic acid, and molybdo-tungstosilic acid.

The heteropoly acid compound may be, for example, at least one of compounds represented by the following Formula (4) to the following Formula (7).

HₓA_{y}(BD₆O₂₄).zH₂O (4)

(In Formula (4), A is one of Li, Na, K, Rb, Cs, Mg, Ca, A₁, NH₄, ammonium salt, and phosphonium salt; B is one of P, Si, As, and Ge; D is at least one of Ti, V, Cr, Mn, Fe, Co, Ni, Cu, Zn, Ga, Zr, Nb, Mo, Tc, Rh, Cd, In, Sn, Ta, W, Re, and Tl; x to z satisfy 0≦x≦8, 0≦y≦8, and 0≦z≦50; and at least one of x and y is not 0.)

HₓA_{y}(BD₁₂O₄₀).zH₂O (5)

(In Formula (5), A is one of Li, Na, K, Rb, Cs, Mg, Ca, Al, NH₄, ammonium salt, and phosphonium salt; B is one of P, Si, As, and Ge; D is at least one of Ti, V, Cr, Mn, Fe, Co, Ni, Cu, Zn, Ga, Zr, Nb, Mo, Tc, Rh, Cd, In, Sn, Ta, W, Re, and Tl; x to z satisfy 0≦x≦4, 0≦y≦4, and 0≦z≦50; and at least one of x and y is not 0.)

HₓA_{y}(B₂D₁₈O₆₂).zH₂O (6)

(In Formula (6), A is one of Li, Na, K, Rb, Cs, Mg, Ca, Al, NH₄, ammonium salt, and phosphonium salt; B is one of P, Si, As, and Ge; D is at least one of Ti, V, Cr, Mn, Fe, Co, Ni, Cu, Zn, Ga, Zr, Nb, Mo, Tc, Rh, Cd, In, Sn, Ta, W, Re, and Tl; x to z satisfy 0≦x≦8, 0≦y≦8, and 0≦z≦50; and at least one of x and y is not 0.)

HₓA_{y}(B₅D₃₀O₁₁₀).zH₂O (7)

(In Formula (7), A is one of Li, Na, K, Rb, Cs, Mg, Ca, Al, NH₄, ammonium salt, and phosphonium salt; B is one of P, Si, As, and Ge; D is at least one of Ti, V, Cr, Mn, Fe, Co, Ni, Cu, Zn, Ga, Zr, Nb, Mo, Tc, Rh, Cd, In, Sn, Ta, W, Re, and Tl; x to z satisfy 0≦x≦15, 0≦y≦15, and 0≦z≦50; and at least one of x and y is not 0.)

In particular, at least one of phosphomolybdic acid, tungstophosphoric acid, silicomolybdic acid, and tungstosilicic acid may be preferable, since thereby, higher effects are obtained. Further, the content of the heteropoly acid and/or the like in the cathode active material layer 22B may be preferably from 0.01 wt % to 3 wt % both inclusive, since thereby, gas generation is suppressed without largely lowering the battery capacity and the like.

The heteropoly acid compound may preferably contain a cation such as Li⁺, Na⁺, K⁺, Rb⁺, Cs⁺, R₄N⁺, and R₄P⁺ (in the formulas, R is H or a hydrocarbon group with carbon number of 10 or less). Further, the cation may be more preferably one of Li⁺, tetra-normal-butyl ammonium, and tetra-normal-butyl phosphonium.

Specifically, the heteropoly acid compound may be, for example, a heteropolytungstic acid compound such as silicotungstic acid sodium, phosphotungstic acid sodium, phosphotungstic acid ammonium, and silicotungstic acid tetra-tetra-n-butylphosphonium salt. Further, the heteropoly acid compound may be a heteropolymolybdic acid compound such as phosphomolybdic acid sodium, phosphomolybdic acid ammonium, and phosphomolybdic acid tri-tetra-n-butyl ammonium salt. Further, examples of the compound containing a plurality of poly elements may include molybdo-tungstophosphoric acid tri-tetra-n-ammonium salt. Two or more of the foregoing examples of the heteropoly acid and the heteropoly acid compound may be used by mixture. Such a heteropoly acid and such a heteropoly acid compound are easily dissolved in a solvent, are stable in a battery, and are less likely to create an adverse result such as a reaction with other material.

As described above, the heteropoly acid and the heteropoly acid compound contribute to suppression of gas generation and the like. Therefore, it may be preferable that a gel coat, more specifically, a gel coat derived from at least one of the heteropoly acid and the heteropoly acid compound be provided on at least one of the cathode 21 and the anode 22. The gel coat contains a deposit that has been deposited in a three-dimensional network state by electrolyzation of the heteropoly acid or the heteropoly acid compound at the time of charge or at the time of preparatory charge. That is, the gel coat contains at least one of an amorphous polyacid having one or more poly elements and an amorphous polyacid salt compound. When the amorphous polyacid and the amorphous polyacid compound are impregnated with the electrolytic solution, the coat becomes gelatinous. Although the coat grows in a thickness direction, the coat is less likely to adversely affect conductivity of lithium ions. In addition thereto, the coat prevents intense flow of a large current resulting from contact between the separator 23 and the cathode 21 or between the separator 23 and the anode 22, and suppresses instantaneous heat generation of the secondary battery. The gel coat may be provided on at least part of the surface of the cathode 21 and the like. It is to be noted that existence, the composition, and the like of the gel coat are allowed to be checked with the use of a scanning electron microscope (SEM), X-ray absorption fine structure (XAFS) analysis, TOF-SIMS method and/or the like.

Regarding the foregoing gel coat, it may be preferable that, in the anode 22, it may be preferable that part of at least one of the polyacid and the polyacid compound be reduced so that the valency of the poly atom be less than hexavalent, while at least one of the polyacid and the polyacid compound that be not reduced and exists hexavalent as the valency of the poly atomic ion exists at the same time. When such a poly atomic ion in a reduced state and such a poly atomic ion in a nonreduced state exist concurrently, stability of the polyacid and the polyacid compound having gas absorption effect is improved, and therefore, improved resistance to the electrolytic solution is prospective. The reduction state of at least one of the polyacid and the polyacid compound that are deposited is allowed to be checked by X-ray photoelectron spectroscopy (XPS) analysis. In this case, cleaning may be preferably made with the use of dimethyl carbonate after disassembling the battery in order to remove a low-volatile solvent component and an electrolyte salt existing on the surface. Sampling may be desirably made under inactive atmosphere as long as possible. Further, in the case where superimposition of peaks attributable to a plurality of energies are suspected, presence or absence of peak attributable to a tungsten ion or a molybdenum ion having valency of hexavalent or less is allowed to be determined by performing separation of peaks with the use of wave analysis on measured spectrums.

[Operation of Secondary Battery]

In the secondary battery, for example, at the time of charge, lithium ions extracted from the cathode 21 are inserted in the anode 22 through the electrolytic solution. Further, at the time of discharge, lithium ions extracted from the anode 22 are inserted in the cathode 21 through the electrolytic solution.

In this case, as described above, in order to complete the generation reaction of the irreversible capacity in the anode 22 at the time of the initial charge, the charging voltage (such as 4.6 V) at the time of the initial charge may be preferably higher than the charging voltage (such as 4.35 V) at the time of charge after the initial charge.

[Method of Manufacturing Secondary Battery]

The secondary battery may be manufactured, for example, by the following procedure.

First, the cathode 21 is fabricated. The foregoing cathode active material is mixed with a cathode binder, a cathode electric conductor, and the like as necessary to prepare a cathode mixture. Subsequently, the cathode mixture is dispersed in an organic solvent or the like to obtain paste cathode mixture slurry. Subsequently, both surfaces of the cathode current collector 21A are coated with the cathode mixture slurry, and the cathode mixture slurry is dried to form the cathode active material layer 21B. Subsequently, the cathode active material layer 21B is compression-molded with the use of a roll pressing machine and/or the like while heating the cathode active material layer 21B as necessary. In this case, compression-molding may be repeated several times.

Further, the anode 22 is fabricated by a procedure similar to that of the cathode 21 described above. An anode active material is mixed with an anode binder, an anode electric conductor, and the like as necessary to prepare an anode mixture, and the anode mixture is dispersed in an organic solvent or the like to form paste anode mixture slurry. Subsequently, both surfaces of the anode current collector 22A are coated with the anode mixture slurry, and the anode mixture slurry is dried to form the anode active material layer 22B. Thereafter, the anode active material layer 22B is compression-molded as necessary.

Further, an electrolyte salt is dispersed in a solvent to prepare an electrolytic solution.

Finally, the secondary battery is assembled with the use of the cathode 21 and the anode 22. The cathode lead 25 is attached to the cathode current collector 21A with the use of a welding method and/or the like, and the anode lead 26 is attached to the anode current collector 22A with the use of a welding method and/or the like similarly. Subsequently, the cathode 21 and the anode 22 are layered with the separator 23 in between and are spirally wound, and thereby, the spirally wound electrode body 20 is fabricated. Thereafter, the center pin 24 is inserted in the center of the spirally wound electrode body. Subsequently, the spirally wound electrode body 20 is sandwiched between the pair of insulating plates 12 and 13, and the spirally wound electrode body 20 is contained in the battery can 11. In this case, an end of the cathode lead 25 is attached to the safety valve mechanism 15 with the use of a welding method and/or the like, and an end of the anode lead 26 is attached to the battery can 11 with the use of a welding method and/or the like similarly. Subsequently, an electrolytic solution is injected into the battery can 11, and the separator 23 is impregnated with the electrolytic solution. Subsequently, at the open end of the battery can 11, the battery cover 14, the safety valve mechanism 15, and the PTC device 16 are fixed by being swaged with the gasket 17.

[Function and Effect of Secondary Battery]

According to the cylindrical-type secondary battery, the cathode active material layer 21B of the cathode 21 contains the foregoing cathode active material. Therefore, as described above in detail for the cathode active material, a high battery capacity is stably obtained. In addition thereto, lowering of the discharge capacity and gas generation are suppressed even when charge and discharge are repeated, and resistance increase is suppressed. Therefore, superior battery characteristics are obtainable. In particular, in the case where a metal-based material or an oxide thereof to increase the irreversible capacity is used as an anode active material of the anode 22, higher effects are obtainable. Further, when low-crystalline carbon, an amorphous carbon, or the like is used as an anode active material, the irreversible capacity is increased as well, and therefore, similar effects are obtainable. Other functions and other effects are similar to those of the cathode active material.

[2-2. Cathode and Lithium Ion Secondary Battery (Laminated-Film-Type)]

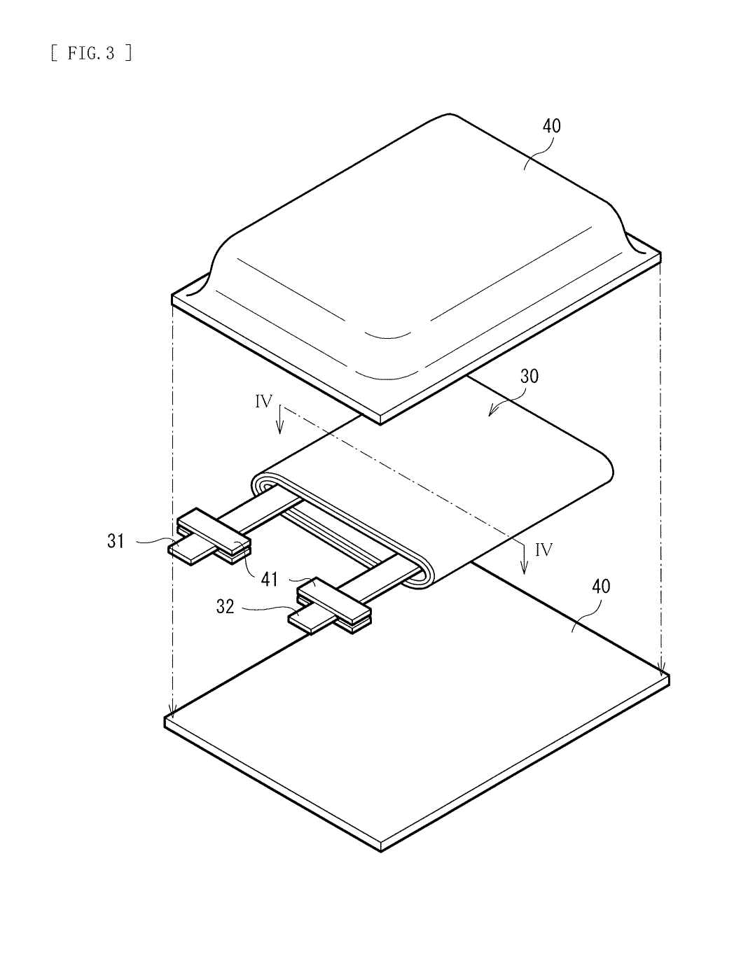

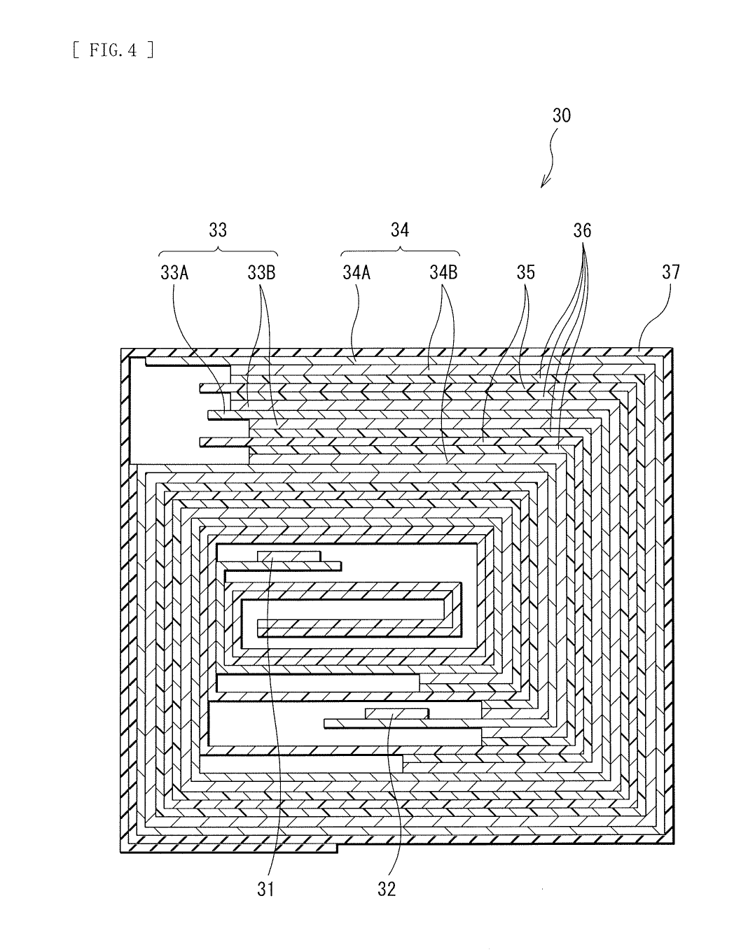

FIG. 3 illustrates an exploded perspective configuration of another secondary battery. FIG. 4 illustrates an enlarged cross-section taken along a line IV-IV of a spirally wound electrode body 30 illustrated in FIG. 3. In the following description, the elements of the cylindrical-type secondary battery described above will be used as needed.

[Whole Configuration of Secondary Battery]

The secondary battery is a so-called laminated-film-type lithium ion secondary battery. The spirally wound electrode body 30 is contained in a film-like outer package member 40. The spirally wound electrode body 30 is formed by laminating a cathode 33 and an anode 34 with a separator 35 and an electrolyte layer 36 in between, and subsequently spirally winding the resultant laminated body. In the spirally wound electrode body 30, a cathode lead 31 is attached to the cathode 33, and an anode lead 32 is attached to the anode 34. It is to be noted that the outermost periphery of the spirally wound electrode body 30 is protected by a protective tape 37.

The cathode lead 31 and the anode lead 32 may be, for example, led out from inside to outside of the outer package member 40 in the same direction. The cathode lead 31 may be made, for example, of an electrically-conductive material such as aluminum, and the anode lead 32 may be made, for example, of an electrically-conducive material such as copper, nickel, and stainless steel. These electrically-conductive materials may be in the shape, for example, of a thin plate or mesh.

The outer package member 40 may be a laminated film in which, for example, a fusion bonding layer, a metal layer, and a surface protective layer are laminated in this order. In the laminated film, for example, outer edges of two film fusion bonding layers may be fusion-bonded so that the fusion bonding layers and the spirally wound electrode body 30 are opposed to each other. Alternatively, the two films may be attached to each other by an adhesive or the like. Examples of the fusion bonding layer may include a film made of polyethylene, polypropylene, or the like. Examples of the metal layer may include an aluminum foil. Examples of the surface protective layer may include a film made of nylon, polyethylene terephthalate, or the like.

In particular, as the outer package member 40, an aluminum laminated film in which a polyethylene film, an aluminum foil, and a nylon film are laminated in this order may be preferable. However, the outer package member 40 may be made of a laminated film having other laminated structure, a polymer film such as polypropylene, or a metal film.

An adhesive film 41 to protect from outside air intrusion is inserted between the outer package member 40 and the cathode lead 31 and between the outer package member 40 and the anode lead 32. The adhesive film 41 is made of a material having adhesibility with respect to the cathode lead 31 and the anode lead 32. Examples of the material having adhesibility may include polyolefin resins such as polyethylene, polypropylene, modified polyethylene, and modified polypropylene.

The cathode 33 may have, for example, a cathode active material layer 33B on both surfaces of a cathode current collector 33A. The anode 34 may have, for example, an anode active material layer 34B on both surfaces of an anode current collector 34A. The configurations of the cathode current collector 33A, the cathode active material layer 33B, the anode current collector 34A, and the anode active material layer 34B may be, for example, similar to the configurations of the cathode current collector 21A, the cathode active material layer 21B, the anode current collector 22A, and the anode active material layer 22B, respectively. That is, the cathode active material layer 33B contains the lithium-containing compound as a cathode active material. Further, the configuration of the separator 35 may be similar to the configuration of the separator 23.

[Electrolyte Layer]

In the electrolyte layer 36, an electrolytic solution is supported by a polymer compound. The electrolyte layer 36 is a so-called gel electrolyte, since thereby, high ion conductivity (for example, 1 mS/cm or more at room temperature) is obtained and liquid leakage of the electrolytic solution is prevented. The electrolyte layer 36 may contain other material such as an additive as necessary.

The polymer compound includes any one or more of polymer materials. Examples of the polymer material may include polyacrylonitrile, polyvinylidene fluoride, polytetrafluoroethylene, polyhexafluoropropylene, polyethylene oxide, polypropylene oxide, polyphosphazene, polysiloxane, polyvinyl fluoride, polyvinyl acetate, polyvinyl alcohol, polymethacrylic acid methyl, polyacrylic acid, polymethacrylic acid, styrene-butadiene rubber, nitrile-butadiene rubber, polystyrene, and polycarbonate. In addition thereto, a copolymer may be used. Examples of the copolymer may include a copolymer of vinylidene fluoride and hexafluoro propylene. In particular, polyvinylidene fluoride and the copolymer of vinylidene fluoride and hexafluoro propylene may be preferable, and polyvinylidene fluoride may be more preferable, since such a polymer compound is electrochemically stable.

The composition of the electrolytic solution may be, for example, similar to the composition of the electrolytic solution of the cylindrical-type secondary battery. However, in the electrolyte layer 36 as a gel electrolyte, the solvent of the electrolytic solution refers to a wide concept including not only a liquid solvent but also a material having ion conductivity capable of dissociating the electrolyte salt. Therefore, in the case where a polymer compound having ion conductivity is used, the polymer compound is also included in the solvent.

It is to be noted that the electrolytic solution may be used as it is instead of the gel electrolyte layer 36. In this case, the separator 35 is impregnated with the electrolytic solution.

[Operation of Secondary Battery]

In the secondary battery, for example, at the time of charge, lithium ions extracted from the cathode 33 are inserted in the anode 34 through the electrolyte layer 36, and, at the time of discharge, lithium ions extracted from the anode 34 are inserted in the cathode 21 through the electrolyte layer 36. In this case, in order to complete a generation reaction of an irreversible capacity in the anode 34 at the time of the initial charge, a charging voltage at the time of the initial charge may be preferably higher than a charging voltage at the time of charge after the initial charge.

[Method of Manufacturing Secondary Battery]

The secondary battery including the gel electrolyte layer 36 may be manufactured, for example, by the following three types of procedures.

In the first procedure, the cathode 33 and the anode 34 are fabricated by a fabrication procedure similar to that of the cathode 21 and the anode 22. In this case, the cathode active material layer 33B is formed on both surfaces of the cathode current collector 33A to fabricate the cathode 33, and the anode active material layer 34B is formed on both surfaces of the anode current collector 34A to fabricate the anode 34. Subsequently, a precursor solution containing an electrolytic solution, a polymer compound, and a solvent such as an organic solvent is prepared. Thereafter, the cathode 33 and the anode 34 are coated with the precursor solution to form the gel electrolyte layer 36. Subsequently, the cathode lead 31 is attached to the cathode current collector 33A with the use of a welding method and/or the like, and the anode lead 32 is attached to the anode current collector 34A with the use of a welding method and/or the like. Subsequently, the cathode 33 and the anode 34 are layered with the separator 35 in between and are spirally wound to fabricate the spirally wound electrode body 30. Thereafter, the protective tape 37 is adhered to the outermost periphery thereof. Subsequently, after the spirally wound electrode body 30 is sandwiched between two pieces of film-like outer package members 40, the outer edges of the outer package members 40 are bonded with the use of a thermal fusion bonding method and/or the like. Thereby, the spirally wound electrode body 30 is enclosed into the outer package members 40. In this case, the adhesive films 41 are inserted between the cathode lead 31 and the outer package member 40 and between the anode lead 32 and the outer package member 40.

In the second procedure, the cathode lead 31 is attached to the cathode 33, and the anode lead 52 is attached to the anode 34. Subsequently, the cathode 33 and the anode 34 are layered with the separator 35 in between and are spirally wound to fabricate a spirally wound body as a precursor of the spirally wound electrode body 30. Thereafter, the protective tape 37 is adhered to the outermost periphery thereof. Subsequently, after the spirally wound body is sandwiched between two pieces of the film-like outer package members 40, the outermost peripheries except for one side are bonded with the use of a thermal fusion bonding method and/or the like to obtain a pouched state, and the spirally wound body is contained in the pouch-like outer package member 40. Subsequently, a composition for electrolyte containing an electrolytic solution, a monomer as a raw material for the polymer compound, a polymerization initiator, and other materials such as a polymerization inhibitor as necessary is prepared, and the composition for electrolyte is injected into the pouch-like outer package member 40. Thereafter, the outer package member 40 is hermetically sealed with the use of a thermal fusion bonding method and/or the like. Subsequently, the monomer is thermally polymerized, and thereby, a polymer compound is formed. Thereby, the gel electrolyte layer 36 is formed.

In the third procedure, the spirally wound body is fabricated and contained in the pouch-like outer package member 40 in a manner similar to that of the foregoing second procedure, except that the separator 35 with both surfaces coated with a polymer compound is used. Examples of the polymer compound with which the separator 35 is coated may include a polymer (a homopolymer, a copolymer, or a multicomponent copolymer) containing vinylidene fluoride as a component. Specific examples thereof may include polyvinylidene fluoride, a binary copolymer containing vinylidene fluoride and hexafluoro propylene as components, and a ternary copolymer containing vinylidene fluoride, hexafluoro propylene, and chlorotrifluoroethylene as components. It is to be noted that, in addition to the polymer containing vinylidene fluoride as a component, other one or more polymer compounds may be used. Subsequently, an electrolytic solution is prepared and injected into the outer package member 40. Thereafter, the opening of the outer package member 40 is hermetically sealed with the use of a thermal fusion bonding method and/or the like. Subsequently, the resultant is heated while a weight is applied to the outer package member 40, and the separator 35 is adhered to the cathode 33 and the anode 34 with the polymer compound in between. Thereby, the polymer compound is impregnated with the electrolytic solution, and accordingly, the polymer compound is gelated to form the electrolyte layer 36.

In the third procedure, swollenness of the secondary battery is suppressed more than in the first procedure. Further, in the third procedure, the monomer as a raw material of the polymer compound, the solvent, and the like are less likely to be left in the electrolyte layer 36 compared to in the second procedure. Therefore, the formation step of the polymer compound is favorably controlled. Therefore, the cathode 33, the anode 34, and the separator 35 sufficiently adhere to the electrolyte layer 36.

[Function and Effect of Secondary Battery]

According to the laminated-film-type secondary battery, the cathode active material layer 33B of the cathode 33 contains the foregoing cathode active material. Therefore, superior battery characteristics are achievable for a reason similar to that of the cylindrical-type secondary battery. Other functions and other effects are similar to those of the cylindrical-type secondary battery.

[2-3. Cathode and Lithium Metal Secondary Battery]

A secondary battery described here is a lithium metal secondary battery in which the capacity of the anode is obtained by precipitation and dissolution of lithium metal. The secondary battery has a configuration similar to that of the foregoing cylindrical-type lithium ion secondary battery, except that the anode active material layer 22B is formed of the lithium metal, and the secondary battery is manufactured by a procedure similar to that of the cylindrical-type lithium ion secondary battery.

In the secondary battery, the lithium metal is used as an anode active material, and thereby, high energy density is obtained. The anode active material layer 22B may exist at the time of assembling, or the anode active material layer 22B does not necessarily exist at the time of assembling and may be formed of the lithium metal precipitated at the time of charge. Further, the anode active material layer 22B may be used as a current collector, and thereby, the anode current collector 22A may be omitted.

In the secondary battery, for example, at the time of charge, lithium ions may be discharged from the cathode 21, and may be precipitated as the lithium metal on the surface of the anode current collector 22A through the electrolytic solution. Further, for example, at the time of discharge, the lithium metal may be eluded as lithium ions from the anode active material layer 22B, and may be inserted in the cathode 21 through the electrolytic solution.

According to the lithium metal secondary battery, since the cathode active material layer 21B of the cathode 21 contains the foregoing cathode active material, superior battery characteristics are obtainable for a reason similar to that of the lithium ion secondary battery. Other functions and other effects are similar to those of the lithium ion secondary battery. It is to be noted that the secondary battery described here is not limited to the cylindrical-type secondary battery, and may be a laminated-film-type secondary battery.

### 3. Applications of Secondary Battery

Next, description will be given of application examples of the foregoing secondary battery.

Applications of the secondary battery are not particularly limited as long as the secondary battery is applied to a machine, a device, an instrument, an apparatus, a system (collective entity of a plurality of devices and the like), or the like that is allowed to use the secondary battery as a driving electric power source, an electric power storage source for electric power storage, or the like. The secondary battery used as an electric power source may be a main electric power source (an electric power source used preferentially), or may be an auxiliary electric power source (an electric power source used instead of a main electric power source or used being switched from the main electric power source). In the latter case, the main electric power source type is not limited to the secondary battery.

Examples of applications of the secondary battery may include portable electronic apparatuses (including mobile electronic apparatuses) such as a video camcorder, a digital still camera, a mobile phone, a notebook personal computer, a cordless phone, a headphone stereo, a portable radio, a portable television, and a personal digital assistant. Further examples thereof may include a mobile lifestyle electric appliance such as an electric shaver; a memory device such as a backup electric power source and a memory card; an electric power tool such as an electric drill and an electric saw; a battery pack used as an electric power source for a notebook personal computer or the like; a medical electronic apparatus such as a pacemaker and a hearing aid; an electric vehicle such as an electric automobile (including a hybrid automobile); and an electric power storage system such as a home battery system for storing electric power for emergency or the like. It goes without saying that an application other than the foregoing applications may be adopted.

In particular, the secondary battery is effectively applicable to the battery pack, the electric vehicle, the electric power storage system, the electric power tool, the electronic apparatus, or the like. One reason for this is that, in these applications, since superior battery characteristics are demanded, performance is effectively improved with the use of the secondary battery according to the present technology. It is to be noted that the battery pack is an electric power source using a secondary battery, and is a so-called assembled battery or the like. The electric vehicle is a vehicle that works (runs) with the use of a secondary battery as a driving electric power source. As described above, the electric vehicle may be an automobile (such as a hybrid automobile) including a drive source other than a secondary battery. The electric power storage system is a system using a secondary battery as an electric power storage source. For example, in a home electric power storage system, electric power is stored in the secondary battery as an electric power storage source, the electric power is consumed as necessary, and thereby, home electric products and the like become usable. The electric power tool is a tool in which a movable section (such as a drill) is moved with the use of a secondary battery as a driving electric power source. The electronic apparatus is an apparatus executing various functions with the use of a secondary battery as a driving electric power source (an electric power supply source).

Description will be specifically given of some application examples of the secondary battery. It is to be noted that the configurations of the respective application examples explained below are merely examples, and may be changed as appropriate.

[3-1. Battery Pack]

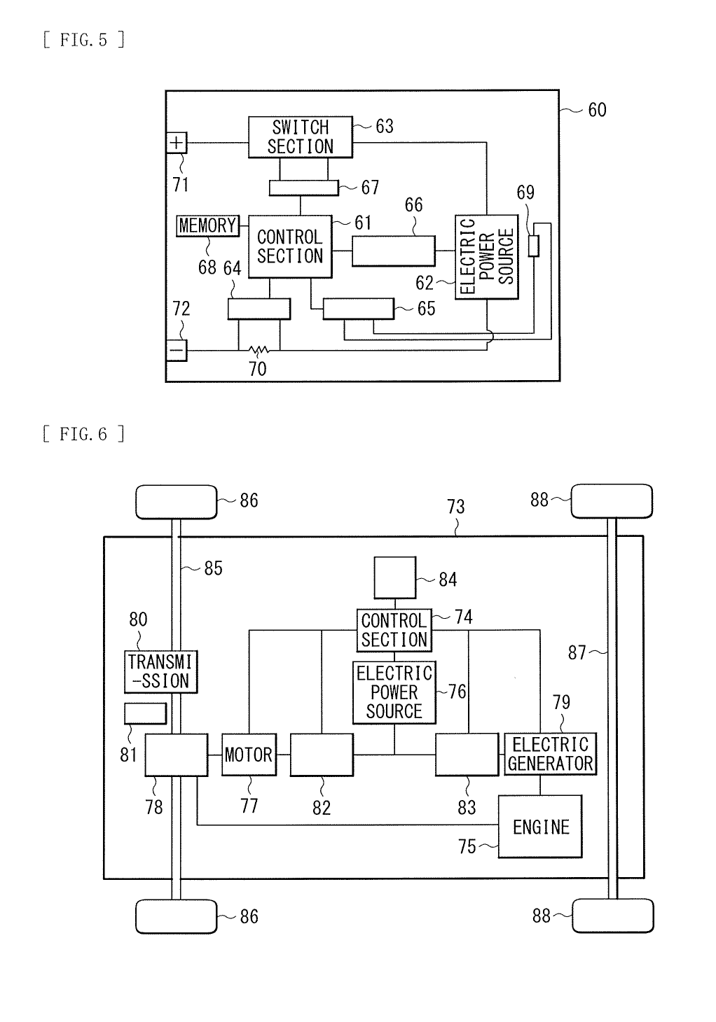

FIG. 5 illustrates a block configuration of a battery pack. For example, as illustrated in FIG. 5, the battery pack may include a control section 61, an electric power source 62, a switch section 63, a current measurement section 64, a temperature detection section 65, a voltage detection section 66, a switch control section 67, a memory 68, a temperature detection element 69, a current detection resistance 70, a cathode terminal 71, and an anode terminal 72 in a housing 60 made of a plastic material and/or the like.

The control section 61 controls an operation of the whole battery pack (including a usage state of the electric power source 62), and may include, for example, a central processing unit (CPU) and/or the like. The electric power source 62 includes one or more secondary batteries (not illustrated). The electric power source 62 may be, for example, an assembled battery including two or more secondary batteries. Connection type of these secondary batteries may be a series-connected type, may be a parallel-connected type, or a mixed type thereof. As an example, the electric power source 62 may include six secondary batteries connected in a manner of dual-parallel and three-series.

The switch section 63 switches the usage state of the electric power source 62 (whether or not the electric power source 62 is connectable to an external device) according to an instruction of the control section 61. The switch section 63 may include, for example, a charge control switch, a discharge control switch, a charging diode, a discharging diode, and the like (not illustrated). The charge control switch and the discharge control switch may each be, for example, a semiconductor switch such as a field-effect transistor (MOSFET) using a metal oxide semiconductor.

The current measurement section 64 measures a current with the use of the current detection resistance 70, and outputs the measurement result to the control section 61. The temperature detection section 65 measures temperature with the use of the temperature detection element 69, and outputs the measurement result to the control section 61. The temperature measurement result may be used, for example, for a case in which the control section 61 controls charge and discharge at the time of abnormal heat generation or a case in which the control section 61 performs a correction processing at the time of calculating a remaining capacity. The voltage detection section 66 measures a voltage of the secondary battery in the electric power source 62, performs analog-to-digital (A/D) conversion on the measured voltage, and supplies the resultant to the control section 61.

The switch control section 67 controls operations of the switch section 63 according to signals inputted from the current measurement section 64 and the voltage detection section 66.

The switch control section 67 executes control so that a charging current is prevented from flowing in a current path of the electric power source 62 by disconnecting the switch section 63 (charge control switch) in the case where, for example, a battery voltage reaches an overcharge detection voltage. Thereby, in the electric power source 62, only discharge is allowed to be performed through the discharging diode. It is to be noted that, for example, in the case where a large current flows at the time of charge, the switch control section 67 blocks the charging current.

Further, the switch control section 67 executes control so that a discharging current is prevented from flowing in the current path of the electric power source 62 by disconnecting the switch section 63 (discharge control switch) in the case where, for example, a battery voltage reaches an overdischarge detection voltage. Thereby, in the electric power source 62, only charge is allowed to be performed through the charging diode. It is to be noted that, for example, in the case where a large current flows at the time of discharge, the switch control section 67 blocks the discharging current.

It is to be noted that, in the secondary battery, for example, the overcharge detection voltage may be 4.2 V±0.05 V, and the over-discharge detection voltage may be 2.4 V±0.1 V.

The memory 68 may be, for example, an EEPROM as a non-volatile memory or the like. The memory 68 may store, for example, numerical values calculated by the control section 61 and information (such as an internal resistance in the initial state) of the secondary battery measured in a manufacturing step. It is to be noted that, in the case where the memory 68 stores a full charging capacity of the secondary battery, the control section 10 is allowed to comprehend information such as a remaining capacity.

The temperature detection element 69 measures temperature of the electric power source 62, and outputs the measurement result to the control section 61. The temperature detection element 69 may be, for example, a thermistor or the like.

The cathode terminal 71 and the anode terminal 72 are terminals connected to an external device (such as a notebook personal computer) driven using the battery pack or an external device (such as a battery charger) used for charging the battery pack. The electric power source 62 is charged and discharged through the cathode terminal 71 and the anode terminal 72.

[3-2. Electric Vehicle]

FIG. 6 illustrates a block configuration of a hybrid automobile as an example of electric vehicles. For example, as illustrated in FIG. 6, the electric vehicle may include a control section 74, an engine 75, an electric power source 76, a driving motor 77, a differential 78, an electric generator 79, a transmission 80, a clutch 81, inverters 82 and 83, and various sensors 84 in a housing 73 made of metal. In addition thereto, the electric vehicle may include, for example, a front drive shaft 85 and a front tire 86 that are connected to the differential 78 and the transmission 80, a rear drive shaft 87, and a rear tire 88.

The electric vehicle may run with the use, for example, of one of the engine 75 and the motor 77 as a drive source. The engine 75 is a main power source, and may be, for example, a petrol engine. In the case where the engine 75 is used as a power source, drive power (torque) of the engine 75 may be transferred to the front tire 86 or the rear tire 88 through the differential 78, the transmission 80, and the clutch 81 as drive sections, for example. It is to be noted that the torque of the engine 75 may also be transferred to the electric generator 79. Due to the torque, the electric generator 79 generates alternating-current electric power. The alternating-current electric power is converted into direct-current electric power through the inverter 83, and the converted power is stored in the electric power source 76. In contrast, in the case where the motor 77 as a conversion section is used as a power source, electric power (direct-current electric power) supplied from the electric power source 76 is converted into alternating-current electric power through the inverter 82. The motor 77 may be driven by the alternating-current electric power. Drive power (torque) obtained by converting the electric power by the motor 77 may be transferred to the front tire 86 or the rear tire 88 through the differential 78, the transmission 80, and the clutch 81 as the drive sections, for example.

It is to be noted that, alternatively, the following mechanism may be adopted. In the mechanism, when speed of the electric vehicle is reduced by an unillustrated brake mechanism, the resistance at the time of speed reduction is transferred to the motor 77 as torque, and the motor 77 generates alternating-current electric power by the torque. It may be preferable that the alternating-current electric power be converted to direct-current electric power through the inverter 82, and the direct-current regenerative electric power be stored in the electric power source 76.

The control section 74 controls operations of the whole electric vehicle, and, for example, may include a CPU and/or the like. The electric power source 76 includes one or more secondary batteries (not illustrated). Alternatively, the electric power source 76 may be connected to an external electric power source, and electric power may be stored by receiving the electric power from the external electric power source. The various sensors 84 may be used, for example, for controlling the number of revolutions of the engine 75 or for controlling opening level (throttle opening level) of an unillustrated throttle valve. The various sensors 84 may include, for example, a speed sensor, an acceleration sensor, an engine frequency sensor, and/or the like.

It is to be noted that the description has been given above of the hybrid automobile as an electric vehicle. However, examples of the electric vehicles may include a vehicle (electric automobile) working with the use of only the electric power source 76 and the motor 77 without using the engine 75.

[3-3. Electric Power Storage System]

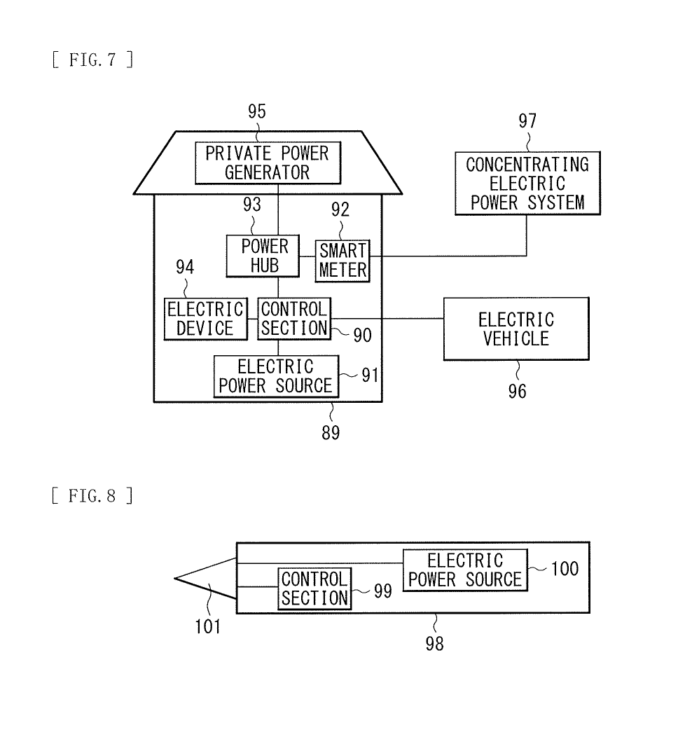

FIG. 7 illustrates a block configuration of an electric power storage system. For example, as illustrated in FIG. 7, the electric power storage system may include a control section 90, an electric power source 91, a smart meter 92, and a power hub 93 inside a house 89 such as a general residence and a commercial building.

In this case, the electric power source 91 may be connected to, for example, an electric device 94 arranged inside the house 89, and may be connected to an electric vehicle 96 parked outside the house 89. Further, for example, the electric power source 91 may be connected to a private power generator 95 arranged inside the house 89 through the power hub 93, and may be connected to an external concentrating electric power system 97 thorough the smart meter 92 and the power hub 93.

It is to be noted that the electric device 94 may include, for example, one or more home electric appliances such as a refrigerator, an air conditioner, a television, and a water heater. The private power generator 95 may be, for example, one or more of a solar power generator, a wind-power generator, and the like. The electric vehicle 96 may be, for example, one or more of an electric automobile, an electric motorcycle, a hybrid automobile, and the like. The concentrating electric power system 97 may be, for example, one or more of a thermal power plant, an atomic power plant, a hydraulic power plant, a wind-power plant, and the like.

The control section 90 controls an operation of the whole electric power storage system (including a usage state of the electric power source 91), and, for example, may include a CPU and/or the like. The electric power source 91 includes one or more secondary batteries (not illustrated). The smart meter 92 may be, for example, an electric power meter compatible with a network arranged in the house 89 demanding electric power, and may be communicable with an electric power supplier. Accordingly, for example, while the smart meter 92 communicates with outside as necessary, the smart meter 92 controls the balance between supply and demand in the house 89 and allows effective and stable energy supply.

In the electric power storage system, for example, electric power may be stored in the electric power source 91 from the concentrating electric power system 97 as an external electric power source through the smart meter 92 and the power hub 93, and electric power may be stored in the electric power source 91 from the private power generator 95 as an independent electric power source through the power hub 93. The electric power stored in the electric power source 91 is supplied to the electric device 94 or to the electric vehicle 96 as necessary according to an instruction of the control section 91. Therefore, the electric device 94 becomes operable, and the electric vehicle 96 becomes chargeable. That is, the electric power storage system is a system capable of storing and supplying electric power in the house 89 with the use of the electric power source 91.

The electric power stored in the electric power source 91 is arbitrarily usable. Therefore, for example, electric power is allowed to be stored in the electric power source 91 from the concentrating electric power system 97 in the middle of the night when an electric rate is inexpensive, and the electric power stored in the electric power source 91 is allowed to be used during daytime hours when an electric rate is expensive.

It is to be noted that the foregoing electric power storage system may be arranged for each household (family unit), or may be arranged for a plurality of households (family units).

[3-4. Electric Power Tool]

FIG. 8 illustrates a block configuration of an electric power tool. For example, as illustrated in FIG. 8, the electric power tool may be an electric drill, and may include a control section 99 and an electric power source 100 in a tool body 98 made of a plastic material and/or the like. For example, a drill section 101 as a movable section may be attached to the tool body 98 in an operable (rotatable) manner.

The control section 99 controls operations of the whole electric power tool (including a usage state of the electric power source 100), and may include, for example, a CPU and/or the like. The electric power source 100 includes one or more secondary batteries (not illustrated). The control section 99 allows electric power to be supplied from the electric power source 100 to the drill section 101 as necessary according to an operation of an unillustrated operation switch to operate the drill section 101.

### EXAMPLES

Specific examples of the present technology will be described in detail.

### Examples 1 to 35

### Synthesis of Cathode Active Material

A lithium-containing compound as a cathode active material was obtained by the following procedure. First, lithium carbonate (Li₂CO₃), manganese carbonate (MnCO₃), cobalt hydroxide (Co(OH)₂), nickel hydroxide (Ni(OH)₂), and aluminum nitrate enneahydrate (Al(NO₃)₃.9H₂O) as raw materials were mixed, and thereafter, the resultant mixture was sufficiently pulverized by a ball mill with the use of water as a dispersion medium. In this case, the mixture ratio was adjusted so that the composition (molar ratio) of an obtained composite oxide became Li:Mn:Co:Ni:Al=1.13:0.6:0.2:0.2:0.01. Subsequently, the mixture was fired in the air at 850 deg C. for 12 hours to synthesize a composite oxide (Li_{1.13}(Mn_{0.6}Co_{0.2}NH_{0.2})_{0.87}Al_{0.01}O₂) containing the element M1 (Al). Subsequently, magnesium phosphate as an M2-containing compound was measured so that the molar ratio of Li:Mg=100:1 was obtained with respect to the composite oxide and was mixed with the composite oxide. Thereafter, the resultant mixture was treated for one hour with the use of a mechanochemical device to cover the surface of the composite oxide with the M2-containing compound. Finally, the composite oxide was fired at 900 deg C. for 3 hours at a rate of temperature increase of 3 deg C. per minute. Thereby, a lithium-containing compound in which the element M2 (Mg) was inserted in the surface layer region of the composite oxide containing the element M1 (Al) was obtained.

In addition thereto, with the use of other row materials and other M2-containing compounds, lithium-containing compounds illustrated in Table 1 and Table 2 were obtained. Such other row materials were lithium hydroxide (LiOH), magnesium phosphate, titanium dioxide (TiO₂), and the like. Such other M2-containing compounds were aluminum nitrate enneahydrate, glucose, nickel hydroxide, lithium fluoride (LiF), and the like.

Upon obtaining the lithium-containing compounds, mixture ratios of the raw materials, blending amounts of the M2-containing compounds, firing temperature, firing time, and the like were adjusted so that the mole fraction R1(%) where the mass ratio R2 was 0.05%, the mole fraction R1(%) where the mass ratio R2 was 0.1%, and the contents of the element M2 became values illustrated in Table 1 and Table 2.

It is to be noted that, when the obtained lithium-containing compound was analyzed with the use of SEM/EDX in the case where the surface of the composite oxide was covered with the M2-containing compound, it was confirmed that the element M2 was distributed substantially constantly on the particle surfaces of the lithium-containing compound. Further, particles of the lithium-containing compound were cut to expose cross sections, and thereafter, element distribution in a radius direction was analyzed with the use of Auger electron spectroscopy. As a result, it was confirmed that the element M2 existed in the surface layer region, and the abundance of the element M2 was gradually decreased from the surface layer side to the central side.

[Fabrication of Secondary Battery]

The laminated-film-type lithium ion secondary battery illustrated in FIG. 3 and FIG. 4 was fabricated in order to examine battery characteristics with the use of the foregoing cathode active material.

Upon fabricating the cathode 33, 90 parts by mass of a cathode active material, 5 parts by mass of a cathode binder (polyvinylidene fluoride (PVDF)), and 5 parts by mass of a cathode electric conductor (Ketjen black) were mixed to obtain a cathode mixture. Subsequently, the cathode mixture was dispersed in an organic solvent (N-methyl-2-pyrrolidone (NMP)) to obtain cathode mixture slurry. Subsequently, both surfaces of the cathode current collector 33A (an aluminum foil being 15 μm thick) were coated with the cathode mixture slurry uniformly, and the cathode mixture slurry was dried by hot air to form the cathode active material layer 33B. Finally, the cathode active material layer 33B was compression-molded with the use of a roll pressing machine, and thereafter, the cathode active material layer 33B was cut in the shape of a strip (48 mm×300 mm)

Upon fabricating the anode 34, each of the anode active materials illustrated in Table 1 and Table 2 and 20 wt % NMP solution of polyimide were mixed at a mass ratio of 7:2 to obtain anode mixture slurry. The anode active materials were graphite (C: median diameter=15 μm) and silicon oxide (SiO: median diameter=7 μm). The graphite was mesocarbon microbead (MCMB). Subsequently, both surfaces of the anode current collector 34A (a copper foil being 15 μm thick) were coated with the anode mixture slurry uniformly, and thereafter, the anode mixture slurry was dried at 80 deg C. Subsequently, the resultant was compression-molded with the use of a roll pressing machine. Thereafter, the resultant was heated at 700 deg C. for 3 hours to form the anode active material layer 34B. Finally, the anode active material layer 34B was cut in the shape of a strip (50 mm×310 mm).

Upon assembling the secondary battery, the cathode lead 25 made of aluminum was welded to the cathode current collector 33A of the cathode 33, and the anode lead 26 made of copper was welded to the anode current collector 34A of the anode 34. Subsequently, the cathode 33 and the anode 34 were laminated with the separator 35 (a microporous polyethylene film being 25 μm thick) in between, and the resultant laminated body was spirally wound in the longitudinal direction to fabricate the spirally wound electrode body 30. Thereafter, the protective tape 37 was adhered to the outermost peripheral portion of the spirally wound electrode body 30. Subsequently, the spirally wound electrode body 30 was sandwiched between two film-like outer package members 40. Thereafter, the outermost peripheries on three sides of the outer package members 40 were thermally fusion-bonded to obtain a pouch-like shape. The outer package member 40 was a moisture-resistant aluminum laminated film in which a nylon film having a thickness of 25 μm, an aluminum foil having a thickness of 40 μm, and a polypropylene film having a thickness of 30 μm were laminated from outside. Finally, an electrolytic solution was injected into the outer package members 40, and the separator 35 was impregnated with the electrolytic solution. Thereafter, each of the remaining one side of the outer package members 40 was thermally fusion-bonded to each other in reduced-pressure environment. The electrolytic solution was obtained by dissolving an electrolyte salt (LiPF₆) in a solvent (ethylene carbonate (EC) and ethylmethyl carbonate (EMC)). The composition (the mass ratio) of the solvent was EC:EMC=50:50, and the content of the electrolyte salt with respect to the solvent was 1 mol/dm³ (=1 mol/l).

It is to be noted that, for comparison, cathode active materials were obtained and secondary batteries were fabricated by a similar procedure, except that configuration conditions of lithium-containing compounds were changed as illustrated in Table 2 and Table 3.

[Measurement of Battery Characteristics]

As battery characteristics of the secondary battery, battery capacity characteristics, cycle characteristics, battery swollenness characteristics, and conservation characteristics were examined. Results illustrated in Table 1 to Table 3 were obtained.

Upon examining the battery capacity characteristics and the cycle characteristics, the discharge capacity (mAh) at the second cycle and the cycle retention ratio (%) after 300 cycles were obtained by the following procedure. In this case, the secondary battery was charged and discharged two cycles in the environment of 23 deg C. to measure the discharge capacity (mAh) at the second cycle. Subsequently, the secondary battery was charged and discharged until the total number of cycles reached 300 in the same environment, and the discharge capacity (mAh/g) at the 300th cycle was measured. Finally, [cycle retention ratio (%)=(discharge capacity at the 300th cycle/discharge capacity at the second cycle)ₓ100] was calculated. At the time of charge and discharge at the first cycle, charge was performed at a constant current of 1000 mA until the battery voltage reached 4.6 V, subsequently, charge was performed at a constant voltage of 4.6 V until the current value reached 1 mA, and thereafter, charge was performed at a constant current of 500 mA until the battery voltage reached 2.5 V. At the time of charge and discharge on and after the second cycle, charge and discharge were performed under conditions similar to those of the first cycle, except that the target battery voltage at the time of constant current charge was changed to 4.35 V.

Upon examining the battery swollenness characteristics, after the thickness (mm) of the secondary battery before charge and discharge was measured in the environment of 23 deg C., the secondary battery was charged and discharged one cycle, and thereafter, the thickness (mm) after charge and discharge was measured. From the measurement result thereof, [swollenness (mm)=thickness after charge and discharge-thickness before charge and discharge] was calculated. It is to be noted that the charge and discharge conditions were similar to the charge and discharge conditions at the first cycle in the case of examining the battery capacity characteristics and the like.

Upon examining the conservation characteristics, the secondary battery was charged and discharged in the environment of 23 deg C. to measure a discharge capacity (mAh). Subsequently, the secondary battery was charged again, and the secondary battery was conserved for 300 hours in the environment of 60 deg C. Thereafter, the secondary battery was discharged to measure the discharge capacity (mAh) at the second cycle. From the result, [conservation retention ratio (%)=(discharge capacity at the second cycle (after conservation)/discharge capacity at the first cycle (before conservation)×100)] was calculated. It is to be noted that the charge and discharge conditions were similar to those in the case of examining the battery capacity characteristics and the like.

TABLE 1

| | Cathode active material | | | | | | | | | | | | | | |
|---|---|---|---|---|---|---|---|---|---|---|---|---|---|---|---|
| | (Li₁₊ₐ(Mn_{b}Co_{c}Ni_{1-b-c})₁₋ₐM1_{d}O₂₋ₑ + M2) | | | | | | | | | | | | Cycle | | Conservation |
| | | | | | | | M2 | | R1 (%) | | Anode | Discharge | retention | | retention |
| | | | | | | | | Content | R2 (%) = | R2 (%) = | active | capacity | ratio | Swollenness | ratio |
| Example | a | b | C | d | e | M1 | Type | (mol %) | 0.05 | 0.1 | material | (mAh) | (%) | (mm) | (%) |
| 1 | 0.13 | 0.6 | 0.2 | 0.01 | 0 | Al | Mg | 1 | 0.42 | 0.35 | SiO | 917 | 89 | 8.98 | 93 |
| 2 | 0.13 | 0.6 | 0.2 | 0.01 | 0 | Mg | Al | 1 | 0.34 | 0.33 | SiO | 908 | 89 | 9 | 91 |
| 3 | 0.13 | 0.6 | 0.2 | 0.2 | 0 | Al | Ca | 1 | 0.38 | 0.33 | SiO | 912 | 87 | 8.76 | 90 |
| 4 | 0.05 | 0.6 | 0.2 | 0.05 | 0 | Mg | Ni | 1 | 0.29 | 0.27 | SiO | 888 | 88 | 8.24 | 91 |
| 5 | 0.13 | 0.6 | 0.2 | 0.01 | 0 | Ti | Mg | 1 | 0.31 | 0.29 | SiO | 910 | 80 | 9.05 | 91 |
| 6 | 0.15 | 0.4 | 0.3 | 0.02 | 0 | Al | Mg | 1 | 0.29 | 0.26 | SiO | 898 | 89 | 9.11 | 92 |
| 7 | 0.13 | 0.6 | 0.2 | 0.01 | 0 | Al | Mg | 5 | 0.77 | 0.52 | SiO | 896 | 91 | 9.01 | 90 |
| 8 | 0.2 | 0.6 | 0.2 | 0.01 | 0 | Al | Mg | 1 | 0.35 | 0.3 | SiO | 901 | 89 | 9.21 | 91 |
| 9 | 0.13 | 0.6 | 0.2 | 0.01 | 0 | Al | Mg | 1 | 0.42 | 0.35 | C | 861 | 90 | 7.98 | 89 |
| 10 | 0.13 | 0.6 | 0.2 | 0.01 | 1 | Al | Mg | 1 | 0.36 | 0.33 | SiO | 915 | 87 | 8.79 | 88 |
| 11 | 0.13 | 0.6 | 0.2 | 0.2 | 0 | Al | Mg | 1 | 0.5 | 0.44 | SiO | 911 | 91 | 8.81 | 91 |
| 12 | 0.13 | 0.6 | 0.2 | 0.2 | 0 | Al | F | 1 | 0.38 | 0.37 | SiO | 922 | 87 | 8.78 | 89 |
| 13 | 0.13 | 0.6 | 0.2 | 0.2 | 0 | Ti | Mg | 1 | 0.41 | 0.4 | SiO | 902 | 86 | 9.19 | 89 |
| 14 | 0.13 | 0.6 | 0.2 | 0.01 | 0 | Al | S | 1 | 0.4 | 0.33 | SiO | 875 | 91 | 9.02 | 90 |
| 15 | 0.13 | 0.6 | 0.2 | 0 | 0 | — | Mg | 1 | 0.42 | 0.35 | SiO | 912 | 86 | 9.12 | 86 |

TABLE 2

| | Cathode active material | | | | | | | | | | | | | | |
|---|---|---|---|---|---|---|---|---|---|---|---|---|---|---|---|
| | (Li₁₊ₐ(Mn_{b}Co_{c}Ni_{1-b-c})₁₋ₐM1_{d}O₂₋ₑ + M2) | | | | | | | | | | | | Cycle | | Conservation |
| | | | | | | | M2 | | R1 (%) | | Anode | Discharge | retention | | retention |
| | | | | | | | | Content | R2 (%) = | R2 (%) = | active | capacity | ratio | Swollenness | ratio |
| Example | a | b | C | d | e | M1 | Type | (mol %) | 0.05 | 0.1 | material | (mAh) | (%) | (mm) | (%) |
| 16 | 0.13 | 0.6 | 0.2 | 0.01 | 0 | Al | Mg | 2 | 0.62 | 0.55 | SiO | 872 | 89 | 9.05 | 89 |
| 17 | 0.13 | 0.6 | 0.2 | 0.01 | 0 | Al | Mg | 1 | 0.56 | 0.29 | SiO | 910 | 90 | 9.01 | 92 |
| 18 | 0.13 | 0.6 | 0.2 | 0.01 | 0 | Al | Mg | 1 | 0.3 | 0.25 | SiO | 915 | 89 | 8.92 | 89 |
| 19 | 0.13 | 0.6 | 0.2 | 0.01 | 0 | Al | Mg | 0.01 | 0.23 | 0.2 | SiO | 925 | 86 | 9.15 | 87 |
| 20 | 0.13 | 0.6 | 0.2 | 0.01 | 0 | Al | Mg | 6 | 0.79 | 0.68 | SiO | 865 | 90 | 8.84 | 90 |
| 21 | 0.13 | 0.6 | 0.2 | 0 | 0 | — | — | — | 0 | 0 | SiO | 912 | 64 | 18.6 | 78 |
| 22 | 0.13 | 0.6 | 0.2 | 0.01 | 0 | Al | — | — | 0 | 0 | SiO | 921 | 68 | 8.61 | 81 |
| 23 | 0.13 | 0.6 | 0.2 | 0.01 | 0 | Al | Mg | 10 | 0.88 | 0.8 | SiO | 792 | 81 | 8.55 | 89 |
| 24 | 0.25 | 0.6 | 0.2 | 0.01 | 0 | Ti | Mg | 1 | 0.39 | 0.37 | SiO | 843 | 83 | 20.1 | 90 |
| 25 | 0 | 0.6 | 0.2 | 0.01 | 0 | Ti | Mg | 1 | 0.41 | 0.35 | SiO | 749 | 86 | 8.19 | 92 |
| 26 | 0.13 | 0.2 | 0.2 | 0.01 | 0 | Al | Mg | 1 | 0.4 | 0.34 | SiO | 826 | 87 | 9.21 | 91 |
| 27 | 0.13 | 0.7 | 0.2 | 0.01 | 0 | Al | Mg | 10 | 0.81 | 0.8 | SiO | 855 | 85 | 8.59 | 80 |
| 28 | 0.13 | 0.6 | 0.8 | 0.01 | 0 | Al | Mg | 1 | 0.41 | 0.35 | SiO | 801 | 86 | 8.71 | 86 |
| 29 | 0.13 | 0.6 | 0.2 | 0.01 | 1.1 | Mg | Al | 1 | 0.38 | 0.33 | SiO | 551 | 56 | 8.98 | 85 |
| 30 | 0.13 | 0.6 | 0.2 | 0.3 | 0 | Al | Mg | 1 | 0.4 | 0.31 | SiO | 821 | 82 | 9.12 | 89 |

TABLE 3

| | Cathode active material | | | | | | | | | | | | | | |
|---|---|---|---|---|---|---|---|---|---|---|---|---|---|---|---|
| | (Li₁₊ₐ(Mn_{b}Co_{c}Ni_{1-b-c})₁₋ₐM1_{d}O₂₋ₑ + M2) | | | | | | | | | | | | Cycle | | Conservation |
| | | | | | | | M2 | | R1 (%) | | Anode | Discharge | retention | | retention |
| | | | | | | | | Content | R2 (%) = | R2 (%) = | active | capacity | ratio | Swollenness | ratio |
| Example | a | b | C | d | e | M1 | Type | (mol %) | 0.05 | 0.1 | material | (mAh) | (%) | (mm) | (%) |
| 31 | 0.13 | 0.6 | 0.2 | 0 | 0 | — | — | 10 | 0.81 | 0.7 | SiO | 857 | 88 | 8.89 | 83 |
| 32 | 0.13 | 0.6 | 0.2 | 0.01 | 0 | Mg | Mg | — | 0 | 0 | SiO | 920 | 69 | 9.31 | 78 |
| 33 | 0.13 | 0.6 | 0.2 | 0 | 0 | Al | Mg | 0.5 | 0.19 | 0.11 | SiO | 911 | 70 | 8.93 | 73 |
| 34 | 0.05 | 0.6 | 0.2 | 0.01 | 0 | Al | Mg | 1 | 0.3 | 0.19 | SiO | 842 | 81 | 9.29 | 85 |
| 35 | 0.13 | 0.6 | 0.2 | 0.01 | 0 | Al | Mg | 5 | 0.78 | 0.81 | SiO | 913 | 68 | 9.26 | 71 |

The battery characteristics showed specific tendency according to the composition of the lithium-containing compound, in particular, according to conditions such as presence or absence of the element M2 and transition of the mole fraction R1.

More specifically, in the case where the lithium-containing compound contained only the element M1, the swollenness was largely decreased, while the discharge capacity, the cycle retention ratio, and the conservation retention ratio were increased only slightly. In contrast, in the case where the lithium-containing compound contained the elements M1 and M2, the swollenness was largely decreased, and the discharge capacity, the cycle retention ratio, and the conservation retention ratio were largely increased. Further, in the case where the lithium-containing compound contained only the element M2, high cycle retention ratio and high conservation retention ratio were obtained.

In the case where the lithium-containing compound contained the elements M1 and M2, and a to e in Formula (1) were in respective appropriate ranges, the discharge capacity, the cycle retention ratio, and the conservation retention ratio were increased, and the swollenness was decreased. In contrast, when any of a to e was out of the appropriate ranges, the discharge capacity and the like were lowered.

In this case, in the case where the mole fraction R1 on the central side (R2=0.1%) was smaller than that on the surface layer side (R2=0.05%), the cycle retention ratio and the conservation retention ratio were increased while a high discharge capacity was retained, compared to a reverse situation.

In particular, in the case where the mole fraction R1 was gradually decreased from the surface layer side to the central side and the mole fraction R1 was from 0.2 to 0.8 both inclusive where the mass ratio R2 was from 0.05% to 0.1% both inclusive, the discharge capacity and the like became higher. Further, in the case where the content of the element M2 was from 0.01 mol % to 5 mol % both inclusive, a high discharge capacity and the like were obtained.

It is to be noted that, focusing attention on the types of the anode active materials, in the case where the metal-based material (SiO) was used, the discharge capacity was further increased than in the case where the carbon material (C) was used. Further, in spite of using the metal-based material and the like, a high cycle retention ratio and a high conservation retention ratio were obtained, and swollenness was decreased.

### Examples 36 to 39

Cathode active materials were synthesized and secondary batteries were fabricated by procedures similar to those of Examples 1 to 35, except that tungstosilicic acid (H₄[SiW₁₂O₄₀].nH₂O) as a heteropolyacid was contained in the cathode mixture as illustrated in Table 4. When battery characteristics of the secondary batteries were examined, results illustrated in Table 4 were obtained.

TABLE 4

Cathode active material
(Li₁₊ₐ(Mn_{b}Co_{c}Ni_{1-b-c})₁₋ₐM1_{d}O₂₋ₑ + M2)

| | | | | | | | | | | | Additive | |
|---|---|---|---|---|---|---|---|---|---|---|---|---|
| | | | | | | | M2 | | R1 (%) | | | Additive |
| | | | | | | | | Content | R2 (%) = | R2 (%) = | | amount |
| Example | a | b | C | d | E | M1 | Type | (mol %) | 0.05 | 0.1 | Type | (wt %) |
| 36 | 0.13 | 0.3 | 0.1 | 0.01 | 0 | Al | Mg | 1 | 0.4 | 0.34 | (H₄[SiW₁₂O₄₀]•nH₂O) | 0.5 |
| 37 | 0.13 | 0.6 | 0.2 | 0.01 | 0 | Al | Mg | 1 | 0.42 | 0.35 | | 0.3 |
| 38 | 0.13 | 0.5 | 0.2 | 0.01 | 0 | Al | Mg | 1 | 0.41 | 0.36 | | 0.3 |
| 39 | 0.13 | 0.6 | 0.2 | 0.01 | 0 | Ti | Mg | 0.05 | 0.22 | 0.2 | | 0.5 |

| | | | Cycle | | Conservation |
|---|---|---|---|---|---|
| | Anode | Discharge | retention | | retention |
| | active | capacity | ratio | Swollenness | ratio |
| Example | material | (mAh) | (%) | (mm) | (%) |
| 36 | SiO | 908 | 86 | 4.06 | 93 |
| 37 | SiO | 927 | 88 | 4.95 | 91 |
| 38 | Si | 1120 | 90 | 5.17 | 92 |
| 39 | SiO | 908 | 86 | 4.13 | 88 |

In the case cathode active material 33B contained the heteropolyacid, swollenness was largely decreased while the discharge capacity, the cycle retention ratio, and the conservation retention ratio were substantially retained compared to in the case where the heteropolyacid was not contained.

From the results of Table 1 to Table 4, in the case where the mole fraction R1 shown in Formula (2) on the central side was smaller than that on the surface layer side in the lithium-containing compound in which the element M2 was inserted in the crystal structure of the surface layer region of the composite oxide shown in Formula (1), superior battery characteristics were obtained.

The present technology has been described above referring to the embodiment and Examples. However, the present technology is not limited to the examples described in the embodiment and Examples, and may be variously modified. For example, the description has been given with the specific examples of the case in which the battery structure is the cylindrical type or the laminated film type, and the battery element has the spirally wound structure. However, applicable structures are not limited thereto. The secondary battery of the present technology is similarly applicable to a battery having other battery structure such as a square-type battery, a coin-type battery, and a button-type battery, or a battery in which the battery element has other structure such as a laminated structure.

Further, the description has been given of the case using Li as an electrode reactant. However, the electrode reactant is not necessarily limited thereto. As an electrode reactant, for example, other Group 1 element such as Na and K, a Group 2 element such as Mg and Ca, or other light metal such as Al may be used. The effect of the present technology may be obtained without depending on the electrode reactant type, and therefore, even if the electrode reactant type is changed, a similar effect is obtainable.

Further, with regard to the mole fraction RE the appropriate range derived from the results of Examples have been described. However, such description does not totally deny possibility that the mole fraction R1 would be out of the foregoing range. That is, the foregoing appropriate range is a particularly preferable range for obtaining the effects of the present technology. Therefore, as long as the effects of the present technology are obtained, the mole fraction R1 may be somewhat out of the foregoing range. The same is applicable to the mass ratio R2 and the content of the element M2.

It is possible to achieve at least the following configurations from the above-described example embodiment of the technology.

(1) A secondary battery including:

a cathode;

an anode; and

an electrolytic solution, wherein

the cathode includes a lithium-containing compound,

the lithium-containing compound is a compound obtained by inserting an element M2 different from an element M1 in a crystal structure of a surface layer region of a composite oxide represented by a following Formula (1),

the element M2 is at least one of Mg, Ca, Ti, Zr, S, F, Fe, Cu, B, Al, P, C, Mn, Ni, and Co, and

a mole fraction R1 represented by a following Formula (2) on a central side of the lithium-containing compound is smaller than the mole fraction R1 on a surface layer side of the lithium-containing compound,

Li₁₊ₐ(Mn_{b}Co_{c}Ni_{1-b-c})₁₋ₐM1_{d}O₂₋ₑ (1)

where M1 is at least one of Al, Mg, Zr, Ti, Ba, B, Si, and Fe; and a to e satisfy 0<a<0.25, 0.5≦b<0.7, 0≦c<1−b, 0≦d≦1, and 0≦e≦1,

R1 (percent)=(a substance amount of the element M2/sum of substance amounts of Mn, Co, Ni, and the element M2)×100 (2).

(2) The secondary battery according to (1), wherein

the mole fraction R1 is gradually decreased from the surface layer side of the lithium-containing compound to the central side of the lithium-containing compound, and

the mole fraction R1 is from 0.2 to 0.8 both inclusive where a mass ratio R2 (percent) represented by a following Formula (3) is from 0.05 percent to 0.1 percent both inclusive,

R2 (percent)=(sum of masses of Mn, Co, Ni, and the element M2/an entire mass of the lithium-containing compound)×100 (3).

(3) The secondary battery according to (1) or (2), wherein a content of the element M2 in the lithium-containing compound is from 0.01 mol percent to 5 mol percent both inclusive with respect to a content of Li.
(4) The secondary battery according to any one of (1) to (3), wherein the a in the Formula (1) satisfies 0.1<a<0.25.
(5) The secondary battery according to any one of (1) to (4), wherein

the lithium-containing compound is a compound obtained by covering a surface of the composite oxide with a compound containing the element M2 as a constituent element by a mechanochemical reaction, and firing the resultant, and

the compound containing the element M2 as the constituent element forms a solid solution with the composite oxide.

(6) The secondary battery according to any one of (1) to (5), wherein

the anode includes a metal-based material, and

the metal-based material includes at least one of Si and Sn as constituent elements.

(7) The secondary battery according to (6), wherein the metal-based material is SiOᵥ (0.2<v<1.4).
(8) The secondary battery according to any one of (1) to (7), wherein at least one of the cathode, the anode, and the electrolytic solution contains at least one of a heteropoly acid and a heteropoly acid compound.
(9) The secondary battery according to any one of (1) to (8), wherein

a gel coat is provided on at least one of the cathode and the anode, and

the gel coat includes at least one of an amorphous polyacid and an amorphous polyacid salt compound, the amorphous polyacid containing one or more types of poly elements.

(10) The secondary battery according to (9), wherein

the gel coat is derived from at least one of a heteropoly acid and a heteropoly acid compound, and

at least one of the polyacid and the polyacid salt compound includes a hexavalent poly atom ion and a poly atom ion having valency less than hexavalent.

(11) The secondary battery according to (10), wherein each of the heteropoly acid and the heteropoly acid compound is at least one of compounds represented by a following Formula (4) to a following Formula (7),

HₓA_{y}(BD₆O₂₄).zH_{b}O (4)

where A is one of Li, Na, K, Rb, Cs, Mg, Ca, Al, NH₄, ammonium salt, and phosphonium salt; B is one of P, Si, As, and Ge; D is at least one of Ti, V, Cr, Mn, Fe, Co, Ni, Cu, Zn, Ga, Zr, Nb, Mo, Tc, Rh, Cd, In, Sn, Ta, W, Re, and Tl; x to z satisfy 0≦x≦8, 0≦y≦8, and 0≦z≦50; and at least one of x and y is not 0,

HₓA_{y}(BD₁₂O₄₀).zH_{b}O (5)

where A is one of Li, Na, K, Rb, Cs, Mg, Ca, A₁, NH₄, ammonium salt, and phosphonium salt; B is one of P, Si, As, and Ge; D is at least one of Ti, V, Cr, Mn, Fe, Co, Ni, Cu, Zn, Ga, Zr, Nb, Mo, Tc, Rh, Cd, In, Sn, Ta, W, Re, and Tl; x to z satisfy 0≦x≦4, 0≦y≦4, and 0≦z≦50; and at least one of x and y is not 0,

HₓA_{y}(B₂D₁₈O₆₂).zH_{b}O (6)

where A is one of Li, Na, K, Rb, Cs, Mg, Ca, A₁, NH₄, ammonium salt, and phosphonium salt; B is one of P, Si, As, and Ge; D is at least one of Ti, V, Cr, Mn, Fe, Co, Ni, Cu, Zn, Ga, Zr, Nb, Mo, Tc, Rh, Cd, In, Sn, Ta, W, Re, and Tl; x to z satisfy 0≦x≦8, 0≦y≦8, and 0≦z≦50; and at least one of x and y is not 0,

HₓA_{y}(B₅D₃₀O₁₁₀).zH_{b}O (7)

where A is one of Li, Na, K, Rb, Cs, Mg, Ca, A₁, NH₄, ammonium salt, and phosphonium salt; B is one of P, Si, As, and Ge; D is at least one of Ti, V, Cr, Mn, Fe, Co, Ni, Cu, Zn, Ga, Zr, Nb, Mo, Tc, Rh, Cd, In, Sn, Ta, W, Re, and Tl; x to z satisfy 0≦x≦15, 0≦y≦15, and 0≦z≦50; and at least one of x and y is not 0.
(12) The secondary battery according to (10), wherein the heteropoly acid is at least one of phosphomolybdic acid, tungstophosphoric acid, silicomolybdic acid, and tungstosilicic acid.
(13) The secondary battery according to any one of (1) to (12), wherein the secondary battery is a lithium secondary battery.
(14) A cathode active material, wherein

the cathode active material is a lithium-containing compound, the lithium-containing compound being obtained by inserting an element M2 different from an element M1 in a crystal structure of a surface layer region of a composite oxide represented by a following Formula (1),

the element M2 is at least one of Mg, Ca, Ti, Zr, S, F, Fe, Cu, B, Al, P, C, Mn, Ni, and Co, and

a mole fraction R1 represented by a following Formula (2) on a central side of the lithium-containing compound is smaller than the mole fraction R1 on a surface layer side of the lithium-containing compound,

Li₁₊ₐ(Mn_{b}Co_{c}Ni_{1-b-c})₁₋ₐM1_{d}O₂₋ₑ (1)

where M1 is at least one of Al, Mg, Zr, Ti, Ba, B, Si, and Fe; and a to e satisfy 0<a<0.25, 0.5≦b<0.7, 0≦c<1−b, 0≦d≦1, and 0≦e≦1,

R1(percent)=(a substance amount of the element M2/sum of substance amounts of Mn, Co, Ni, and the element M2)×100 (2).

(15) A cathode including a lithium-containing compound, the lithium-containing compound being obtained by inserting an element M2 different from an element M1 in a crystal structure of a surface layer region of a composite oxide represented by a following Formula (1), wherein

the element M2 is at least one of Mg, Ca, Ti, Zr, S, F, Fe, Cu, B, Al, P, C, Mn, Ni, and Co, and

a mole fraction R1 represented by a following Formula (2) on a central side of the lithium-containing compound is smaller than the mole fraction R1 on a surface layer side of the lithium-containing compound,

Li₁₊ₐ(Mn_{b}Co_{c}Ni_{1-b-c})₁₋ₐM1_{d}O₂₋ₑ (1)

where M1 is at least one of Al, Mg, Zr, Ti, Ba, B, Si, and Fe; and a to e satisfy 0<a<0.25, 0.5≦b<0.7, 0≦c<1−b, 0≦d≦1, and 0≦e≦1,

R1(percent)=(a substance amount of the element M2/sum of substance amounts of Mn, Co, Ni, and the element M2)×100 (2).

(16) A battery pack including:

a secondary battery according to any one of (1) to (13);

a control section to control a used state of the secondary battery; and

a switch section to switch the used state of the secondary battery according to an instruction of the control section.

(17) An electric vehicle including:

a secondary battery according to any one of (1) to (13);

a conversion section to convert electric power supplied from the secondary battery into drive power;

a drive section to operate according to the drive power; and

a control section to control a used state of the secondary battery.

(18) An electric power storage system including:

a secondary battery according to any one of (1) to (13);

one or more electric devices to be supplied with electric power from the secondary battery; and

a control section to control the supplying of the electric power from the secondary battery to the one or more electric devices.

(19) An electric power tool including:

a secondary battery according to any one of (1) to (13); and

a movable section to be supplied with electric power from the secondary battery.

(20) An electronic apparatus including a secondary battery according to any one of (1) to (13) as an electric power supply source.

The present application contains subject matter related to that disclosed in Japanese Priority Patent Application JP 2012-68936 filed in the Japan Patent Office on Mar. 26, 2012, the entire contents of which is hereby incorporated by reference.

It should be understood by those skilled in the art that various modifications, combinations, sub-combinations and alternations may occur depending on design requirements and other factors insofar as they are within the scope of the appended claims or the equivalents thereof.

1. A secondary battery comprising:
a cathode;
an anode; and
an electrolytic solution, wherein
the cathode includes a lithium-containing compound,
the lithium-containing compound is a compound obtained by inserting an element M2 different from an element M1 in a crystal structure of a surface layer region of a composite oxide represented by a following Formula (1),
the element M2 is at least one of Mg, Ca, Ti, Zr, S, F, Fe, Cu, B, Al, P, C, Mn, Ni, and Co, and
a mole fraction R1 represented by a following Formula (2) on a central side of the lithium-containing compound is smaller than the mole fraction R1 on a surface layer side of the lithium-containing compound,
Li₁₊ₐ(Mn_{b}Co_{c}Ni_{1-b-c})₁₋ₐM1_{d}O₂₋ₑ (1)
where M1 is at least one of Al, Mg, Zr, Ti, Ba, B, Si, and Fe; and a to e satisfy 0<a<0.25, 0.5≦b<0.7, 0≦c<1−b, 0≦d≦1, and 0≦e≦1,
R1 (percent)=(a substance amount of the element M2/sum of substance amounts of Mn, Co, Ni, and the element M2)×100 (2).

2. The secondary battery according to claim 1, wherein
the mole fraction R1 is gradually decreased from the surface layer side of the lithium-containing compound to the central side of the lithium-containing compound, and
the mole fraction R1 is from 0.2 to 0.8 both inclusive where a mass ratio R2 (percent) represented by a following Formula (3) is from 0.05 percent to 0.1 percent both inclusive,
R2 (percent)=(sum of masses of Mn, Co, Ni, and the element M2/an entire mass of the lithium-containing compound)×100 (3).

3. The secondary battery according to claim 1, wherein a content of the element M2 in the lithium-containing compound is from 0.01 mol percent to 5 mol percent both inclusive with respect to a content of Li.

4. The secondary battery according to claim 1, wherein the a in the Formula (1) satisfies 0.1<a<0.25.

5. The secondary battery according to claim 1, wherein
the lithium-containing compound is a compound obtained by covering a surface of the composite oxide with a compound containing the element M2 as a constituent element by a mechanochemical reaction, and firing the resultant, and
the compound containing the element M2 as the constituent element forms a solid solution with the composite oxide.

6. The secondary battery according to claim 1, wherein
the anode includes a metal-based material, and
the metal-based material includes at least one of Si and Sn as constituent elements.

7. The secondary battery according to claim 6, wherein the metal-based material is SiOᵥ (0.2<v<1.4).

8. The secondary battery according to claim 1, wherein at least one of the cathode, the anode, and the electrolytic solution contains at least one of a heteropoly acid and a heteropoly acid compound.

9. The secondary battery according to claim 1, wherein
a gel coat is provided on at least one of the cathode and the anode, and
the gel coat includes at least one of an amorphous polyacid and an amorphous polyacid salt compound, the amorphous polyacid containing one or more types of poly elements.

10. The secondary battery according to claim 9, wherein
the gel coat is derived from at least one of a heteropoly acid and a heteropoly acid compound, and
at least one of the polyacid and the polyacid salt compound includes a hexavalent poly atom ion and a poly atom ion having valency less than hexavalent.

11. The secondary battery according to claim 10, wherein each of the heteropoly acid and the heteropoly acid compound is at least one of compounds represented by a following Formula (4) to a following Formula (7),
HₓA_{y}(BD₆O₂₄).zH_{b}O (4)
where A is one of Li, Na, K, Rb, Cs, Mg, Ca, A₁, NH₄, ammonium salt, and phosphonium salt; B is one of P, Si, As, and Ge; D is at least one of Ti, V, Cr, Mn, Fe, Co, Ni, Cu, Zn, Ga, Zr, Nb, Mo, Tc, Rh, Cd, In, Sn, Ta, W, Re, and Tl; x to z satisfy 0≦x≦8, 0≦y≦8, and 0≦z≦50; and at least one of x and y is not 0,
HₓA_{y}(BD₁₂O₄₀).zH_{b}O (5)
where A is one of Li, Na, K, Rb, Cs, Mg, Ca, Al, NH₄, ammonium salt, and phosphonium salt; B is one of P, Si, As, and Ge; D is at least one of Ti, V, Cr, Mn, Fe, Co, Ni, Cu, Zn, Ga, Zr, Nb, Mo, Tc, Rh, Cd, In, Sn, Ta, W, Re, and Tl; x to z satisfy 0≦x≦4, 0≦y≦4, and 0≦z≦50; and at least one of x and y is not 0,
HₓA_{y}(B₂D₁₈O₆₂).zH_{b}O (6)
where A is one of Li, Na, K, Rb, Cs, Mg, Ca, Al, NH₄, ammonium salt, and phosphonium salt; B is one of P, Si, As, and Ge; D is at least one of Ti, V, Cr, Mn, Fe, Co, Ni, Cu, Zn, Ga, Zr, Nb, Mo, Tc, Rh, Cd, In, Sn, Ta, W, Re, and Tl; x to z satisfy 0≦x≦8, 0≦y≦8, and 0≦z≦50; and at least one of x and y is not 0,
HₓA_{y}(B₅D₃₀O₁₁₀).zH_{b}O (7)
where A is one of Li, Na, K, Rb, Cs, Mg, Ca, Al, NH₄, ammonium salt, and phosphonium salt; B is one of P, Si, As, and Ge; D is at least one of Ti, V, Cr, Mn, Fe, Co, Ni, Cu, Zn, Ga, Zr, Nb, Mo, Tc, Rh, Cd, In, Sn, Ta, W, Re, and Tl; x to z satisfy 0≦x≦15, 0≦y≦15, and 0≦z≦50; and at least one of x and y is not 0.

12. The secondary battery according to claim 10, wherein the heteropoly acid is at least one of phosphomolybdic acid, tungstophosphoric acid, silicomolybdic acid, and tungstosilicic acid.

13. The secondary battery according to claim 1, wherein the secondary battery is a lithium secondary battery.

14. A cathode active material, wherein
the cathode active material is a lithium-containing compound, the lithium-containing compound being obtained by inserting an element M2 different from an element M1 in a crystal structure of a surface layer region of a composite oxide represented by a following Formula (1),
the element M2 is at least one of Mg, Ca, Ti, Zr, S, F, Fe, Cu, B, Al, P, C, Mn, Ni, and Co, and
a mole fraction R1 represented by a following Formula (2) on a central side of the lithium-containing compound is smaller than the mole fraction R1 on a surface layer side of the lithium-containing compound,
Li₁₊ₐ(Mn_{b}Co_{c}Ni_{1-b-c})₁₋ₐM1_{d}O₂₋ₑ (1)
where M1 is at least one of Al, Mg, Zr, Ti, Ba, B, Si, and Fe; and a to e satisfy 0<a<0.25, 0.5≦b<0.7, 0≦c<1−b, 0≦d≦1, and 0≦e≦1,
R1(percent)=(a substance amount of the element M2/sum of substance amounts of Mn, Co, Ni, and the element M2)×100 (2).

15. A cathode including a lithium-containing compound, the lithium-containing compound being obtained by inserting an element M2 different from an element M1 in a crystal structure of a surface layer region of a composite oxide represented by a following Formula (1), wherein
the element M2 is at least one of Mg, Ca, Ti, Zr, S, F, Fe, Cu, B, Al, P, C, Mn, Ni, and Co, and
a mole fraction R1 represented by a following Formula (2) on a central side of the lithium-containing compound is smaller than the mole fraction R1 on a surface layer side of the lithium-containing compound,
Li₁₊ₐ(Mn_{b}Co_{c}Ni_{1-b-c})₁₋ₐM1_{d}O₂₋ₑ (1)
where M1 is at least one of Al, Mg, Zr, Ti, Ba, B, Si, and Fe; and a to e satisfy 0<a<0.25, 0.5≦b<0.7, 0≦c<1−b, 0≦d≦1, and 0≦e≦1,
R1(percent)=(a substance amount of the element M2/sum of substance amounts of Mn, Co, Ni, and the element M2)×100 (2).

16. A battery pack comprising:
a secondary battery;
a control section to control a used state of the secondary battery; and
a switch section to switch the used state of the secondary battery according to an instruction of the control section, wherein
the secondary battery includes a cathode, an anode, and an electrolytic solution,
the cathode includes a lithium-containing compound,
the lithium-containing compound is a compound obtained by inserting an element M2 different from an element M1 in a crystal structure of a surface layer region of a composite oxide represented by a following Formula (1),
the element M2 is at least one of Mg, Ca, Ti, Zr, S, F, Fe, Cu, B, Al, P, C, Mn, Ni, and Co, and
a mole fraction R1 represented by a following Formula (2) on a central side of the lithium-containing compound is smaller than the mole fraction R1 on a surface layer side of the lithium-containing compound,
Li₁₊ₐ(Mn_{b}Co_{c}Ni_{1-b-c})₁₋ₐM1_{d}O₂₋ₑ (1)
where M1 is at least one of Al, Mg, Zr, Ti, Ba, B, Si, and Fe; and a to e satisfy 0<a<0.25, 0.5≦b<0.7, 0≦c<1−b, 0≦d≦1, and 0≦e≦1,
R1(percent)=(a substance amount of the element M2/sum of substance amounts of Mn, Co, Ni, and the element M2)×100 (2).

17. An electric vehicle comprising:
a secondary battery;
a conversion section to convert electric power supplied from the secondary battery into drive power;
a drive section to operate according to the drive power; and
a control section to control a used state of the secondary battery, wherein
the secondary battery includes a cathode, an anode, and an electrolytic solution,
the cathode includes a lithium-containing compound,
the lithium-containing compound is a compound obtained by inserting an element M2 different from an element M1 in a crystal structure of a surface layer region of a composite oxide represented by a following Formula (1),
the element M2 is at least one of Mg, Ca, Ti, Zr, S, F, Fe, Cu, B, Al, P, C, Mn, Ni, and Co, and
a mole fraction R1 represented by a following Formula (2) on a central side of the lithium-containing compound is smaller than the mole fraction R1 on a surface layer side of the lithium-containing compound,
Li₁₊ₐ(Mn_{b}Co_{c}Ni_{1-b-c})₁₋ₐM1_{d}O₂₋ₑ (1)
where M1 is at least one of Al, Mg, Zr, Ti, Ba, B, Si, and Fe; and a to e satisfy 0<a<0.25, 0.5≦b<0.7, 0≦c<1−b, 0≦d≦1, and 0≦e≦1,
R1(percent)=(a substance amount of the element M2/sum of substance amounts of Mn, Co, Ni, and the element M2)×100 (2).

18. An electric power storage system comprising:
a secondary battery;
one or more electric devices to be supplied with electric power from the secondary battery; and
a control section to control the supplying of the electric power from the secondary battery to the one or more electric devices, wherein
the secondary battery includes a cathode, an anode, and an electrolytic solution,
the cathode includes a lithium-containing compound,
the lithium-containing compound is a compound obtained by inserting an element M2 different from an element M1 in a crystal structure of a surface layer region of a composite oxide represented by a following Formula (1),
the element M2 is at least one of Mg, Ca, Ti, Zr, S, F, Fe, Cu, B, Al, P, C, Mn, Ni, and Co, and
a mole fraction R1 represented by a following Formula (2) on a central side of the lithium-containing compound is smaller than the mole fraction R1 on a surface layer side of the lithium-containing compound,
Li₁₊ₐ(Mn_{b}Co_{c}Ni_{1-b-c})₁₋ₐM1_{d}O₂₋ₑ (1)
where M1 is at least one of Al, Mg, Zr, Ti, Ba, B, Si, and Fe; and a to e satisfy 0<a<0.25, 0.5≦b<0.7, 0≦c<1−b, 0≦d≦1, and 0≦e≦1,
R1(percent)=(a substance amount of the element M2/sum of substance amounts of Mn, Co, Ni, and the element M2)×100 (2).

19. An electric power tool comprising:
a secondary battery; and
a movable section to be supplied with electric power from the secondary battery, wherein
the secondary battery includes a cathode, an anode, and an electrolytic solution,
the cathode includes a lithium-containing compound,
the lithium-containing compound is a compound obtained by inserting an element M2 different from an element M1 in a crystal structure of a surface layer region of a composite oxide represented by a following Formula (1),
the element M2 is at least one of Mg, Ca, Ti, Zr, S, F, Fe, Cu, B, Al, P, C, Mn, Ni, and Co, and
a mole fraction R1 represented by a following Formula (2) on a central side of the lithium-containing compound is smaller than the mole fraction R1 on a surface layer side of the lithium-containing compound,
Li₁₊ₐ(Mn_{b}Co_{c}Ni_{1-b-c})₁₋ₐM1_{d}O₂₋ₑ (1)
where M1 is at least one of Al, Mg, Zr, Ti, Ba, B, Si, and Fe; and a to e satisfy 0<a<0.25, 0.5≦b<0.7, 0≦c<1−b, 0≦d≦1, and 0≦e≦1,
R1(percent)=(a substance amount of the element M2/sum of substance amounts of Mn, Co, Ni, and the element M2)×100 (2).

20. An electronic apparatus comprising a secondary battery as an electric power supply source, wherein
the secondary battery includes a cathode, an anode, and an electrolytic solution,
the cathode includes a lithium-containing compound,
the lithium-containing compound is a compound obtained by inserting an element M2 different from an element M1 in a crystal structure of a surface layer region of a composite oxide represented by a following Formula (1),
the element M2 is at least one of Mg, Ca, Ti, Zr, S, F, Fe, Cu, B, Al, P, C, Mn, Ni, and Co, and
a mole fraction R1 represented by a following Formula (2) on a central side of the lithium-containing compound is smaller than the mole fraction R1 on a surface layer side of the lithium-containing compound,
Li₁₊ₐ(Mn_{b}Co_{c}Ni_{1-b-c})₁₋ₐM1_{d}O₂₋ₑ (1)
where M1 is at least one of Al, Mg, Zr, Ti, Ba, B, Si, and Fe; and a to e satisfy 0<a<0.25, 0.5≦b<0.7, 0≦c<1−b, 0≦d≦1, and 0≦e≦1,
R1(percent)=(a substance amount of the element M2/sum of substance amounts of Mn, Co, Ni, and the element M2)×100 (2).
